(19) United States
(12) Patent Application Publication
(10) Pub. No.: US 2026/0295997 A1
(43) Pub. Date: Oct. 1, 2026

(54) DRIVING METHOD AND LIQUID DISCHARGE APPARATUS

(71) Applicant: SEIKO EPSON CORPORATION, Tokyo (JP)

(72) Inventors: Yoshinori ASAKA, SHIOJIRI-SHI (JP); Masahiro ASAMI, SHIOJIRI-SHI (JP); Shunsuke WATANABE, MATSUMOTO-SHI (JP); Koki HIRATA, NAGANO-SHI (JP); Teruaki KAIEDA, MATSUMOTO-SHI (JP)

(21) Appl. No.: 19/576,853

(22) Filed: Mar. 24, 2026

(30) Foreign Application Priority Data
Mar. 26, 2025 (JP) 2025-051895

(51) Int. Cl. B41J 2/045; B41J 3/407; B41J 29/393

(52) U.S. Cl. CPC B41J 2/04543; B41J 2/04551; B41J 2/04573; B41J 2/04588; B41J 3/40733; B41J 29/393; B41J 2/04581; B41J 2029/3935

(57) ABSTRACT

Provided is a method for driving a liquid discharge apparatus including a rotation mechanism that rotates a recording medium having a cylindrical shape and a liquid discharge head including a plurality of nozzle rows. The plurality of nozzle rows are arranged in parallel to a first axis. The rotation mechanism rotates the recording medium about a central axis of the recording medium in a state where the central axis is parallel to the first axis. The method includes: discharging a liquid from a part of the plurality of nozzle rows when an operation mode is a first mode; and discharging the liquid from the part of the plurality of nozzle rows and the other nozzle rows when the operation mode is a second mode. A work gap of the part of the plurality of nozzle rows is narrower than a work gap of the other nozzle rows.

The present application is based on, and claims priority from JP Application Serial Number 2025-051895, filed Mar. 26, 2025, the disclosure of which is hereby incorporated by reference herein in its entirety.

### BACKGROUND

### 1. Technical Field

The present disclosure relates to a driving method and a liquid discharge apparatus.

### 2. Related Art

In the related art, a liquid discharge apparatus that includes a liquid discharge head including a plurality of nozzle rows having a plurality of nozzles for discharging a liquid, such as ink, and forms an image on a recording medium has been in widespread use. The recording medium can also take various shapes. For example, JP-A-2023-107796 discloses a liquid discharge apparatus that forms an image on a can-shaped recording medium.

When printing is performed with a liquid discharge head having a plurality of nozzle rows, a distance to a cylindrical recording medium varies depending on the nozzle row. Therefore, the landing position of a liquid may deviate depending on the distance, and the quality of an image formed on the recording medium may deteriorate. When the nozzle row used for printing is always limited in order to suppress the deterioration of image quality, there arises a problem that the period required for printing is always extended.

### SUMMARY

According to an aspect of the present disclosure, there is provided a method for driving a liquid discharge apparatus including a rotation mechanism that rotates a recording medium having a cylindrical shape and a liquid discharge head that includes a plurality of nozzle rows having a plurality of nozzles for discharging a liquid and forms an image on a side surface of the recording medium, each of the plurality of nozzle rows having a plurality of nozzles arranged along a first axis, the plurality of nozzle rows being arranged in parallel, the rotation mechanism rotating the recording medium about a central axis of the recording medium as a rotation axis in a state where the central axis is parallel to the first axis. The method includes: discharging the liquid from a part of the plurality of nozzle rows when an operation mode in which a nozzle row used to form the image among the plurality of nozzle rows is changed is a first mode; and discharging the liquid from the part of the plurality of nozzle rows and the other nozzle rows different from the part of the plurality of nozzle rows when the operation mode is a second mode different from the first mode. A gap from an opening end of the nozzle in the part of the plurality of nozzle rows to the recording medium is narrower than a gap from an opening end of the nozzle in the other nozzle rows to the recording medium.

According to another aspect of the present disclosure, there is provided a liquid discharge apparatus including: a rotation mechanism that rotates a recording medium having a cylindrical shape; a liquid discharge head that includes a plurality of nozzle rows having a plurality of nozzles for discharging a liquid and forms an image on a side surface of the recording medium; and a control section that controls the rotation mechanism and the liquid discharge head. Each of the plurality of nozzle rows has a plurality of nozzles arranged along a first axis, and the plurality of nozzle rows are arranged in parallel. The rotation mechanism rotates the recording medium about a central axis of the recording medium as a rotation axis in a state where the central axis is parallel to the first axis. The control section performs control to discharge the liquid from a part of the plurality of nozzle rows when an operation mode in which a nozzle row used to form the image among the plurality of nozzle rows is changed is a first mode. The control section performs control to discharge the liquid from the part of the plurality of nozzle rows and the other nozzle rows different from the part of the plurality of nozzle rows when the operation mode is a second mode different from the first mode. A gap from an opening end of the nozzle in the part of the plurality of nozzle rows to the recording medium is narrower than a gap from an opening end of the nozzle in the other nozzle rows to the recording medium.

### BRIEF DESCRIPTION OF THE DRAWINGS

FIG. 1 is a schematic view showing an example of a configuration of a liquid discharge apparatus according to a first embodiment.

FIG. 2 is a view showing the liquid discharge apparatus when viewed in an X2 direction.

FIG. 3 is a diagram showing an electrical configuration of the liquid discharge apparatus according to the first embodiment.

FIG. 4 is a cross-sectional view showing an example of a head chip.

FIG. 5 is a view showing an example of a drive signal.

FIG. 6 is a view showing a work gap in the first embodiment.

FIG. 7 is a view showing an example of landing positions when there is no influence of an air flow generated due to rotation of a recording medium.

FIG. 8 is a view showing an example of the landing positions when there is an influence of the air flow generated due to the rotation of the recording medium.

FIG. 9 is a view showing an example of the landing positions of ink droplets when a printing operation is performed using a second nozzle row and a third nozzle row.

FIG. 10 is a diagram showing functions of the liquid discharge apparatus.

FIG. 11 is a flowchart showing an operation of a control circuit during the printing operation.

FIG. 12 is a diagram showing an electrical configuration of a liquid discharge apparatus according to a first modification example.

FIG. 13 is a flowchart showing an operation of a control circuit.

FIG. 14 is a diagram showing functions of a liquid discharge apparatus according to a second modification example.

FIG. 15 is a view showing an example of content of curvature relationship information.

FIG. 16 is a view showing an example of a curvature radius measurement method.

FIG. 17 is a flowchart showing an operation of a control circuit.

FIG. 18 is a schematic view showing an example of a configuration of a liquid discharge apparatus according to a third modification example.

FIG. 19 is a view showing a work gap in a third modification example.

FIG. 20 is a view showing an example of the landing positions of the ink droplets when the printing operation is performed in a second mode in the third modification example.

FIG. 21 is a view showing an example of the landing positions of the ink droplets when the printing operation is performed in a first mode in the third modification example.

FIG. 22 is a schematic view showing an example of a configuration of a liquid discharge apparatus according to a fourth modification example.

FIG. 23 is a view showing an example of the landing positions of the ink droplets when the printing operation is performed in the second mode in the fourth modification example.

FIG. 24 is a view showing an example of the landing positions of the ink droplets when the printing operation is performed in the first mode in the fourth modification example.

### DESCRIPTION OF EMBODIMENTS

Hereinafter, embodiments carrying out the present disclosure will be described below with reference to the drawings. However, in each drawing, the dimensions and scales of each section are appropriately different from actual ones. Further, since the embodiments which will be described below are suitable specific examples of the present disclosure, various technically preferable limitations are added. However, the scope of the present disclosure is not limited to the embodiments unless description for limiting the present disclosure is made in the following description.

### A. First Embodiment

### A1: Overall Configuration of Liquid Discharge Apparatus

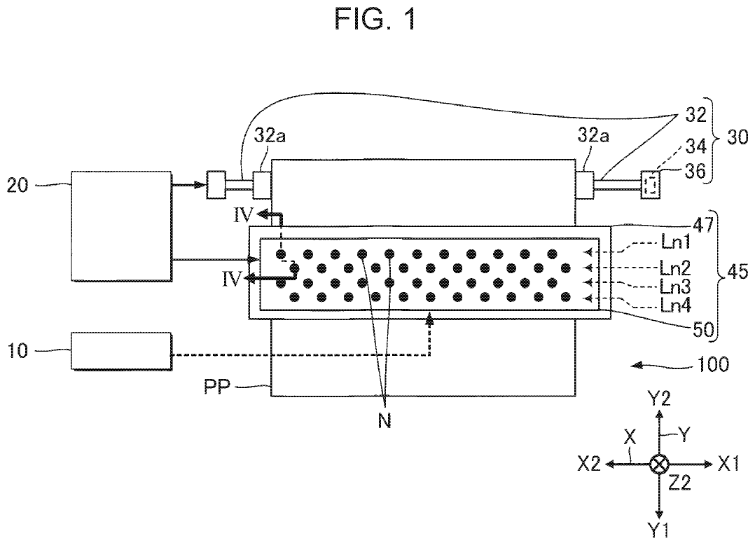

FIG. 1 is a schematic view showing an example of a configuration of a liquid discharge apparatus 100 according to a first embodiment. The liquid discharge apparatus 100 is an ink jet printing apparatus that discharges ink, which is an example of a liquid, as droplets to a recording medium PP to form an image on the recording medium PP. Hereinafter, an operation of forming an image on the recording medium PP may be referred to as a printing operation. The recording medium PP has a cylindrical shape in a range in which an image is formed. A portion having a cylindrical shape means a portion in which the curvature of a side surface is substantially constant, may have the bottom and top surfaces that are not perfect circles, and may not have a part or all of the bottom surface and a part or all of the upper surface. The term “being substantially constant” includes being completely constant and being considered to be constant when manufacturing errors are taken into account. For example, the recording medium PP may be an object that has a space inside, has a recess in the bottom surface, and has a through-hole communicating with the internal space in a part of the top surface, specifically, a can. Alternatively, the recording medium PP may be a substantially cylindrical bottle or a plastic container. Alternatively, the recording medium PP may be recording paper wound around a drum. In addition, the recording medium PP may not have a substantially cylindrical shape in a portion that is not in the range in which an image is formed. For example, the recording medium PP may have a substantially cylindrical shape in a range in which an image is formed and may have a conical shape in a range in which an image is not formed.

As shown in FIG. 1, the liquid discharge apparatus 100 includes a liquid container 10, a control unit 20, a rotation mechanism 30, and a head module 45 having a liquid discharge head 50.

The liquid container 10 stores ink. Specific aspects of the liquid container 10 include, for example, a cartridge that can be attached to and detached from the liquid discharge apparatus 100, a bag-shaped ink pack made of a flexible film, and an ink tank that can be refilled with ink. In addition, any type of ink is stored in the liquid container 10.

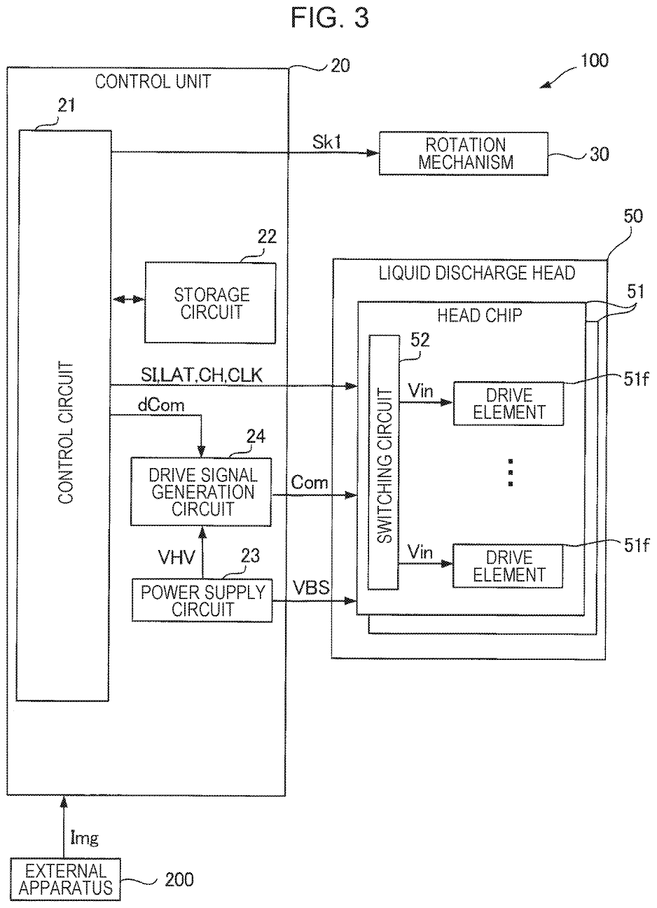

The control unit 20 controls the operation of each element of the liquid discharge apparatus 100. The control unit 20 includes, for example, one or a plurality of processing circuits, such as a central processing unit (CPU) or a field-programmable gate array (FPGA), and one or a plurality of storage circuits, such as a semiconductor memory. A detailed configuration of the control unit 20 will be described below with reference to FIG. 3.

The head module 45 discharges the ink supplied from the liquid container 10 in a Z2 direction under the control of the control unit 20. Hereinafter, the Z2 direction and a Z1 direction opposite to the Z2 direction may be collectively referred to as a direction along the Z-axis.

In addition, directions orthogonal to the X-axis and the Z-axis are referred to as a Y1 direction and a Y2 direction. Hereinafter, the Y1 direction and the Y2 direction may be collectively referred to as a direction along the Y-axis.

The head module 45 has one liquid discharge head 50 and a head fixing substrate 47. The head fixing substrate 47 is a substrate that fixes the liquid discharge head 50. The liquid discharge head 50 is disposed such that a plurality of nozzles N for discharging ink in the Z2 direction are distributed over the entire range of the recording medium PP in an X1 direction and an X2 direction orthogonal to the Z-axis. In the following description, the X1 direction and the X2 direction may be collectively referred to as a direction along the X-axis without distinction. Further, the plurality of nozzles N constitute four nozzle rows Ln that are arranged along the X-axis. In addition, the X-axis is an example of a “first axis”. The head module 45 is a line head having a plurality of nozzles N that are disposed to be distributed over the entire range of the recording medium PP in the direction along the X-axis. Further, the head module 45 may be a line head having a plurality of liquid discharge heads 50 that are disposed such that a plurality of nozzles N are distributed over the entire range of the recording medium PP in the direction along the X-axis. Furthermore, in FIG. 1, the liquid discharge head 50 is viewed in the Z2 direction. Since the plurality of nozzles N are provided on a surface of the liquid discharge head 50 facing the Z2 direction, the plurality of nozzles N are not visible. However, for ease of understanding, the plurality of nozzles N are shown for convenience of description.

The four nozzle rows Ln are a first nozzle row Ln1, a second nozzle row Ln2, a third nozzle row Ln3, and a fourth nozzle row Ln4. Hereinafter, the first nozzle row Ln1, the second nozzle row Ln2, the third nozzle row Ln3, and the fourth nozzle row Ln4 may be referred to as nozzle rows Ln without distinction. The four nozzle rows Ln are disposed to be parallel to the X-axis. In the present specification, the term “being parallel” includes being substantially parallel and being considered to be parallel when manufacturing errors are taken into account. Further, the four nozzle rows Ln are disposed in a staggered pattern. Specifically, when viewed in the direction along the Y-axis, a nozzle N located at the end of the second nozzle row Ln2 or the fourth nozzle row Ln4 in the X2 direction is located between a nozzle N located at the end of the first nozzle row Ln1 or the third nozzle row Ln3 in the X2 direction and a nozzle N of the first nozzle row Ln1 or the third nozzle row Ln3 located in the X1 direction with respect to the nozzle N. In the following description, when i is an integer in the range from 1 to 4, [Lni] may be assigned to an element related to an i-th nozzle row Lni. For example, the nozzle N classified into the first nozzle row Ln1 may be referred to as a nozzle N[Ln1]. In the present embodiment, the liquid discharge head 50 has four nozzle rows Ln, but may have at least two nozzle rows Ln. In addition, the four nozzle rows Ln included in the liquid discharge head 50 are an example of “a plurality of nozzle rows included in a liquid discharge head”.

FIG. 1 is a schematic view showing the liquid discharge apparatus 100 when viewed in the Z2 direction. In a plan view seen in the Z2 direction, the head module 45 and the rotation mechanism 30 partially overlap with each other. However, in FIG. 1, for convenience of description, the head module 45 and the rotation mechanism 30 are shown so as not to overlap with each other.

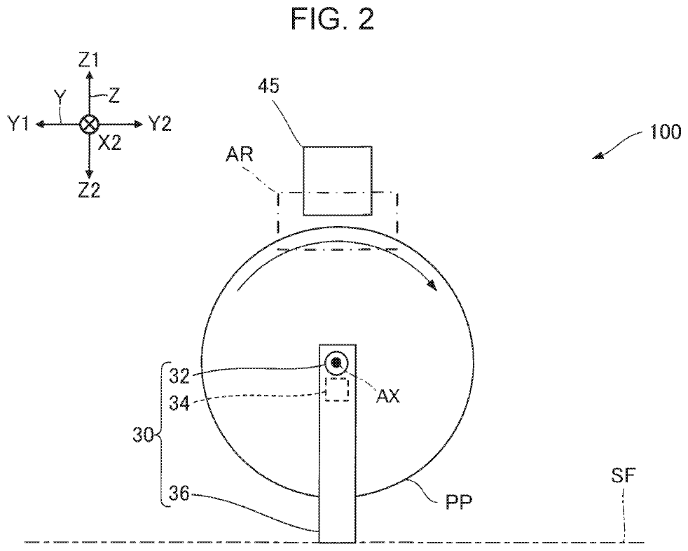

The rotation mechanism 30 rotates the recording medium PP. The rotation mechanism 30 will be described with reference to FIG. 2.

FIG. 2 is a view showing the liquid discharge apparatus 100 when viewed in the X2 direction. The rotation mechanism 30 rotates the recording medium PP about a central axis AX of the recording medium PP as a rotation axis, while supporting the recording medium PP in a state where the central axis AX of the recording medium PP and the X-axis are parallel to each other. As shown in FIGS. 1 and 2, the rotation mechanism 30 includes a pair of shafts 32, a drive mechanism 34, and a support member 36. The pair of shafts 32 are rotation members that support the recording medium PP. The recording medium PP is interposed between the pair of shafts 32 from both ends of the X-axis. Anti-slip plates 32a having a large frictional force are provided in portions of the pair of shafts 32 that come into contact with the recording medium PP in order to interpose the recording medium PP therebetween. However, a method of interposing the recording medium PP is not limited to the anti-slip plates 32a. For example, the pair of shafts 32 may have suction cups. The drive mechanism 34 rotates the shaft 32 about the central axis AX. The drive mechanism 34 includes a motor and a belt or a gear that transmits the rotational force of the motor to the shaft 32. The support member 36 rotatably supports the pair of shafts 32. The support member 36 is a prismatic member that extends along the Z-axis. The drive mechanism 34 is provided inside the support member 36. Alternatively, the drive mechanism 34 may be attached to a side surface of the support member 36. The support member 36 is fixed to a floor SF on which the liquid discharge apparatus 100 is installed. In addition, the rotation mechanism 30 is not limited to the above-described mechanism, and various mechanisms can be adopted that can rotate the recording medium PP about the central axis AX of the recording medium PP as a rotation axis in a state where the central axis AX of the recording medium PP and the X-axis are parallel to each other. For example, a mechanism can be adopted in which a plurality of rollers are brought into contact with the side surface of the recording medium PP from the Z2-direction side of the recording medium PP at a position where the central axis AX of the recording medium PP is the rotation axis in a state where the central axis AX of the recording medium PP and the X-axis are parallel to each other and at least one of the plurality of rollers is rotated by a motor or the like to rotate the recording medium PP.

As understood from FIG. 2, the head module 45 overlaps with the central axis AX in a plan view.

### A2: Electrical Configuration of Liquid Discharge Apparatus 100

FIG. 3 is a diagram showing an electrical configuration of the liquid discharge apparatus 100 according to the first embodiment. As shown in FIG. 3, the liquid discharge head 50 has two head chips 51. However, the liquid discharge head 50 may include three or more head chips 51.

The head chip 51 includes a switching circuit 52 and M drive elements 51f. M is an integer that is equal to or greater than 4.

Under the control of the control unit 20, the switching circuit 52 switches whether or not to supply a drive signal Com output from the control unit 20 as a supply drive signal Vin to each of the plurality of drive elements 51f. Further, in the present embodiment, the head chip 51 includes the switching circuit 52. However, the head chip 51 may not include the switching circuit 52.

A control circuit 21 has a function of controlling the operation of each section of the liquid discharge apparatus 100 and a function of processing various types of data. The control circuit 21 includes, for example, one or more processors such as CPUs. In addition, the control circuit 21 may include a programmable logic device, such as an FPGA, instead of or in addition to the CPU. Further, when the control circuit 21 includes a plurality of processors, the plurality of processors may be mounted on different substrates or the like. Furthermore, the control circuit 21 is an example of a “control section”.

In addition, the control circuit 21 executes a corresponding program to generate a control signal Sk1, a print signal SI, a waveform designation signal dCom, a latch signal LAT, and a clock signal CLK as signals for controlling the operation of each section of the liquid discharge apparatus 100.

The control signal Sk1 is a signal for controlling the driving of the rotation mechanism 30 such that the recording medium PP is rotated at a predetermined speed. The print signal SI is a digital signal for designating an operating state of the drive element 51f. The latch signal LAT is a timing signal that is used in combination with the print signal SI and that defines the discharge timing of ink from each nozzle N of the head chip 51.

Further, the control circuit 21 reads a program stored in the storage circuit 22 and executes the read program to execute a driving method according to the present embodiment.

The storage circuit 22 stores various programs executed by the control circuit 21 and various types of data including image data Img processed by the control circuit 21. The storage circuit 22 includes, for example, semiconductor memories including one or both of a volatile memory, such as a random access memory (RAM), and a non-volatile memory, such as a read only memory (ROM), an electrically erasable programmable read-only memory (EEPROM), or a programmable ROM (PROM). The image data Img is supplied from an external apparatus 200 such as a personal computer or a digital camera. In addition, the storage circuit 22 may be configured as a part of the control circuit 21.

A power supply circuit 23 receives power supplied from a commercial power supply (not shown) and generates various predetermined potentials. The generated various potentials are appropriately supplied to each section of the liquid discharge apparatus 100. The power supply circuit 23 generates, for example, a power supply potential VHV and an offset potential VBS. The offset potential VBS is supplied to the liquid discharge head 50. In addition, the power supply potential VHV is supplied to a drive signal generation circuit 24.

The drive signal generation circuit 24 is a circuit that repeatedly generates the drive signal Com for driving each drive element 51f. Specifically, the drive signal generation circuit 24 includes, for example, a DA conversion circuit and an amplifier circuit. In the drive signal generation circuit 24, the DA conversion circuit converts the waveform designation signal dCom from the control circuit 21 from a digital signal to an analog signal. The amplifier circuit amplifies the analog signal, using the power supply potential VHV from the power supply circuit 23, to generate the drive signal Com. Here, a signal with a waveform actually supplied to the drive element 51f among the waveforms included in the drive signal Com is the supply drive signal Vin. The waveform designation signal dCom is a digital signal for defining the waveform of the drive signal Com.

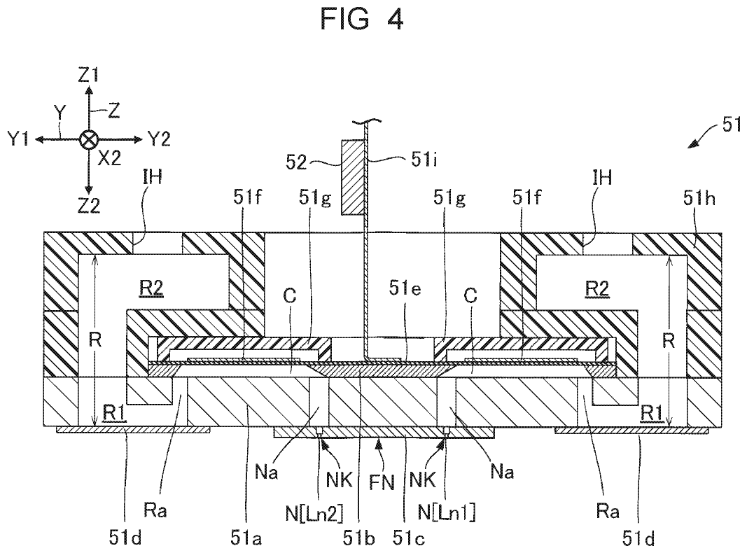

The head chip 51 will be described with reference to FIG. 4. In the present embodiment, the description assumes that one of the two head chips 51 has the first nozzle row Ln1 and the second nozzle row Ln2 and the other head chip 51 has the third nozzle row Ln3 and the fourth nozzle row Ln4.

### A3: Configuration of Head Chip 51

FIG. 4 is a cross-sectional view showing an example of the head chip 51. As shown in FIG. 4, the head chip 51 has M nozzles N arranged in the direction along the X-axis. In FIG. 4, the configuration of the head chip 51 will be described using the head chip 51 having the first nozzle row Ln1 and the second nozzle row Ln2. The M nozzles N are divided into the first nozzle row Ln1 and the second nozzle row Ln2 arranged at intervals in the direction along the Y-axis. Each of the first nozzle row Ln1 and the second nozzle row Ln2 is a set of 0.5×M nozzles N arranged linearly in the direction along the X-axis.

In order to achieve the staggered arrangement shown in FIG. 1, the positions of a plurality of nozzles N of the first nozzle row Ln1 and a plurality of nozzles N of the second nozzle row Ln2 in the direction along the X-axis are different from each other. FIG. 4 shows a cross section of the head chip 51 taken along the line IV-IV in FIG. 1 as viewed in the X2 direction.

As shown in FIG. 4, the head chip 51 includes a flow path substrate 51a, a pressure chamber substrate 51b, a nozzle plate 51c, a vibration absorbing body 51d, a diaphragm 51e, a plurality of drive elements 51f, a protective plate 51g, a case 51h, and a wiring substrate 51i.

The flow path substrate 51a and the pressure chamber substrate 51b are stacked in this order in the Z1 direction to form a flow path for supplying ink to the M nozzles N. The diaphragm 51e, the M drive elements 51f, the protective plate 51g, the case 51h, and the wiring substrate 51i are installed in a region located on the Z1-direction side of a stacked body of the flow path substrate 51a and the pressure chamber substrate 51b. On the other hand, the nozzle plate 51c and the vibration absorbing body 51d are installed in a region located on the Z2 direction side of the stacked body. The elements of the head chip 51 are generally plate-shaped members elongated in the direction along the X-axis and are joined to each other by, for example, an adhesive. Hereinafter, each element of the head chip 51 will be described in order.

The nozzle plate 51c is a plate-shaped member in which M nozzles N are provided for each of the first nozzle row Ln1 and the second nozzle row Ln2. Each of the M nozzles N is a through-hole through which ink passes. In the nozzle N, an opening NK that is formed in a nozzle surface FN of the nozzle plate 51c facing the Z2 direction is an opening end of the nozzle N. The nozzles N are provided in the nozzle surface FN which is a surface of the nozzle plate 51c facing the Z2 direction. The nozzle plate 51c is manufactured by, for example, processing a silicon single crystal substrate with a semiconductor manufacturing technique using a processing technique such as dry etching or wet etching. However, other known methods and materials may be appropriately used to manufacture the nozzle plate 51c. In addition, the cross-sectional shape of the nozzle N is typically circular. However, the cross-sectional shape is not limited thereto and may be, for example, a non-circular shape such as a polygonal shape or an elliptical shape.

A space R1, M supply flow paths Ra, and M communication flow paths Na are provided in the flow path substrate 51a for each of the first nozzle row Ln1 and the second nozzle row Ln2. The space R1 is an elongated opening that extends in the direction along the X-axis in a plan view in the direction along the Z-axis. Each of the supply flow path Ra and the communication flow path Na is a through-hole formed for each nozzle N. Each of the supply flow paths Ra communicates with the space R1.

The pressure chamber substrate 51b is a plate-shaped member in which M pressure chambers C called cavities are provided for each of the first nozzle row Ln1 and the second nozzle row Ln2. The M pressure chambers C are arranged in the direction along the X-axis. Each pressure chamber C is an elongated space that is formed for each nozzle N and extends in the direction along the Y-axis in a plan view. Each of the flow path substrate 51a and the pressure chamber substrate 51b is manufactured by, for example, processing a silicon single crystal substrate with a semiconductor manufacturing technique in the same manner as the nozzle plate 51c. Here, other known methods and materials may be appropriately used to manufacture each of the flow path substrate 51a and the pressure chamber substrate 51b.

The pressure chamber C is a space that is located between the flow path substrate 51a and the diaphragm 51e. M pressure chambers C are arranged in the direction along the X-axis for each of the first nozzle row Ln1 and the second nozzle row Ln2. In addition, the pressure chamber C communicates with each of the communication flow path Na and the supply flow path Ra. Therefore, the pressure chamber C communicates with the nozzle N via the communication flow path Na and communicates with the space R1 via the supply flow path Ra.

The diaphragm 51e is disposed on a surface of the pressure chamber substrate 51b facing the Z1 direction. The diaphragm 51e is a plate-shaped member that can elastically vibrate. The diaphragm 51e has, for example, a first layer and a second layer which are stacked in this order in the Z1 direction. The first layer is, for example, an elastic film made of a silicon oxide (SiO₂). The elastic film is formed, for example, by thermally oxidizing one surface of a silicon single crystal substrate. The second layer is, for example, an insulating film made of a zirconium oxide (ZrO₂). The insulating film is formed, for example, by forming a zirconium layer using a sputtering method and thermally oxidizing the zirconium layer. The diaphragm 51e is not limited to the configuration in which the first layer and the second layer are stacked and may be composed of, for example, a single layer or three or more layers.

M drive elements 51f mutually corresponding to the nozzles N are disposed on a surface of the diaphragm 51e facing the Z1 direction for each of the first nozzle row Ln1 and the second nozzle row Ln2. Each drive element 51f is a passive element that is deformed by the supply of the drive signal Com. Each drive element 51f has an elongated shape extending in the direction along the Y-axis in a plan view. The M drive elements 51f are arranged in the direction along the X-axis so as to correspond to the M pressure chambers C. The drive element 51f overlaps with the pressure chamber C in a plan view.

Each drive element 51f is a piezoelectric element and has a first electrode, a piezoelectric layer, and a second electrode which are stacked in this order in the Z1 direction, which is not shown. One of the first electrode and the second electrode is an individual electrode that is disposed to be separated from each other for each drive element 51f, and the supply drive signal Vin is applied to the one electrode. The other electrode of the first electrode and the second electrode is a band-shaped common electrode that extends in the direction along the X-axis to be continuous over 0.5×M drive elements 51f, and the offset potential VBS is supplied to the other electrode. Examples of a metal material forming these electrodes include metal materials, such as platinum (Pt), aluminum (Al), nickel (Ni), gold (Au), and copper (Cu). Among these metal materials, one type can be used alone, or two or more types can be combined in the form of an alloy or a laminate and then used. The piezoelectric layer is made of a piezoelectric material, such as lead zirconate titanate (Pb(Zr,Ti)O₃), and has, for example, a band shape that extends in the direction along the X-axis so as to be continuous over 0.5×M drive elements 51f. However, the piezoelectric layer may be integrated over 0.5×M drive elements 51f. In this case, in the piezoelectric layer, a through-hole penetrating the piezoelectric layer is provided in a region, which corresponds to a gap between the pressure chambers C adjacent to each other in a plan view, so as to extend in the direction along the X-axis. When the diaphragm 51e vibrates in operative association with the deformation of the drive element 51f, the internal pressure of the pressure chamber C fluctuates, and ink is discharged from the nozzle N.

In the following description, the nozzle N from which ink is discharged due to the deformation of one drive element 51f among the M drive elements 51f may be referred to as a nozzle N corresponding to the drive element 51f.

The protective plate 51g is a plate-shaped member installed on the surface of the diaphragm 51e facing the Z1 direction, protects the M drive elements 51f, and reinforces the mechanical strength of the diaphragm 51e. Here, the M drive elements 51f are accommodated between the protective plate 51g and the diaphragm 51e. For example, the protective plate 51g is made of a resin material.

The case 51h is a member for storing the ink to be supplied to the M pressure chambers C. For example, the case 51h is made of a resin material. A space R2 is provided for each of the first nozzle row Ln1 and the second nozzle row Ln2 in the case 51h. The space R2 is a space communicating with the space R1 and functions as a reservoir R for storing the ink to be supplied to the M pressure chambers C together with the space R1. The case 51h is provided with an inlet IH for supplying the ink to each reservoir R. The ink in each reservoir R is supplied to the pressure chamber C through each supply flow path Ra.

The vibration absorbing body 51d is also referred to as a compliance substrate, is a flexible resin film that constitutes a wall surface of the reservoir R, and absorbs fluctuations of ink pressure in the reservoir R. The vibration absorbing body 51d may be a flexible thin plate made of metal. A surface of the vibration absorbing body 51d facing the Z1 direction is joined to the flow path substrate 51a by an adhesive or the like.

The wiring substrate 51i is mounted on the surface of the diaphragm 51e facing the Z1 direction and is a mounting component for electrically coupling the control unit 20 and the head chip 51. The wiring substrate 51i is, for example, a flexible wiring substrate such as a chip-on-film (COF), a flexible printed circuit (FPC), or a flexible flat cable (FFC). The switching circuit 52 for supplying a drive voltage to each drive element 51f is mounted on the wiring substrate 51i according to the present embodiment.

### A4: Drive Signal Com

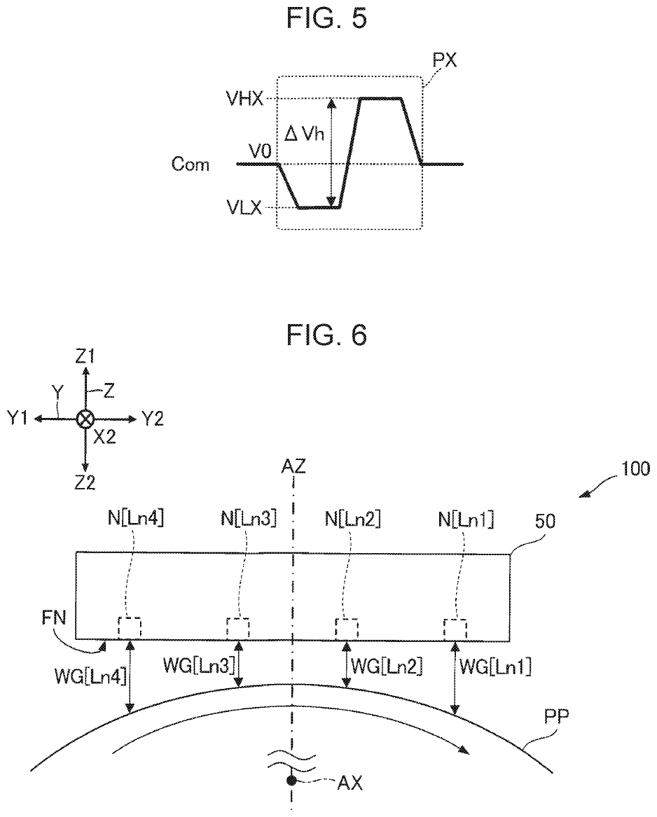

FIG. 5 is a diagram showing an example of the drive signal Com. The drive signal Com has a drive waveform PX. The ink is discharged from the nozzle N corresponding to the drive element 51f by the supply of the drive signal Com having the drive waveform PX to the drive element 51f. The drive waveform PX has a period for which the potential is lowered from an intermediate potential V0 to the lowest potential VLX, a period for which the lowest potential VLX is maintained, a period for which the potential is raised from the lowest potential VLX to the highest potential VHX, a period for which the highest potential VHX is maintained, and a period for which the potential is lowered from the highest potential VHX to the intermediate potential V0.

### A5: For Gap Between Nozzle N and Recording Medium PP

Hereinafter, a gap between the opening end of the nozzle N and the recording medium PP may be referred to as a work gap WG. As shown in FIG. 6, while a nozzle surface in which the first nozzle row Ln1, the second nozzle row Ln2, the third nozzle row Ln3, and the fourth nozzle row Ln4 open is a flat surface, the range of the recording medium PP in which an image is formed has a cylindrical shape. Therefore, the work gap WG[Ln1] of the first nozzle row Ln1 is different from the work gap WG[Ln2] of the second nozzle row Ln2. When a flight speed of ink droplets discharged from the nozzle N is constant, the time required for the ink droplets to land is different between a location where the work gap WG is narrow and a location where the work gap WG is wide. However, since the recording medium PP is transported at a constant speed, the amount of deviation between the landing position of the ink droplet on the recording medium PP and a designed landing position varies depending on the size of the work gap WG, and the quality of the image formed on the recording medium PP may deteriorate. In addition, when the time from the discharge of the ink from the nozzle N to the landing of the ink on the recording medium PP is different, the landing position of the ink on the recording medium PP may deviate due to the air flow generated by the rotation of the recording medium PP. As a result, the quality of the image formed on the recording medium PP may deteriorate. The work gap WG in the present embodiment will be described with reference to FIG. 6.

FIG. 6 is a view showing the work gap WG in the first embodiment. In FIG. 6, a region AR shown in FIG. 2 is enlarged and shown. Further, in FIG. 6, the central axis AX is shown for ease of understanding. When viewed in the X2 direction, four nozzle rows Ln are disposed line-symmetrically with respect to a symmetry axis AZ that passes through the central axis AX and is parallel to the Z-axis. Specifically, the first nozzle row Ln1 and the fourth nozzle row Ln4 are in a line symmetric relationship with respect to the symmetry axis AZ, and the second nozzle row Ln2 and the third nozzle row Ln3 are in a line symmetric relationship with respect to the symmetry axis AZ. When viewed in the X2 direction, the recording medium PP is line-symmetric with respect to the symmetry axis AZ. Therefore, as understood from FIG. 6, the work gap WG[Ln1] of the first nozzle row Ln1 and the work gap WG[Ln4] of the fourth nozzle row Ln4 are substantially the same. Similarly, the work gap WG[Ln2] of the second nozzle row Ln2 and the work gap WG[Ln3] of the third nozzle row Ln3 are substantially the same. The term “being substantially the same” includes being completely the same and being considered to be the same when manufacturing errors are taken into account. As understood from FIG. 6, the work gap WG[Ln1] and the work gap WG[Ln2] are different from each other.

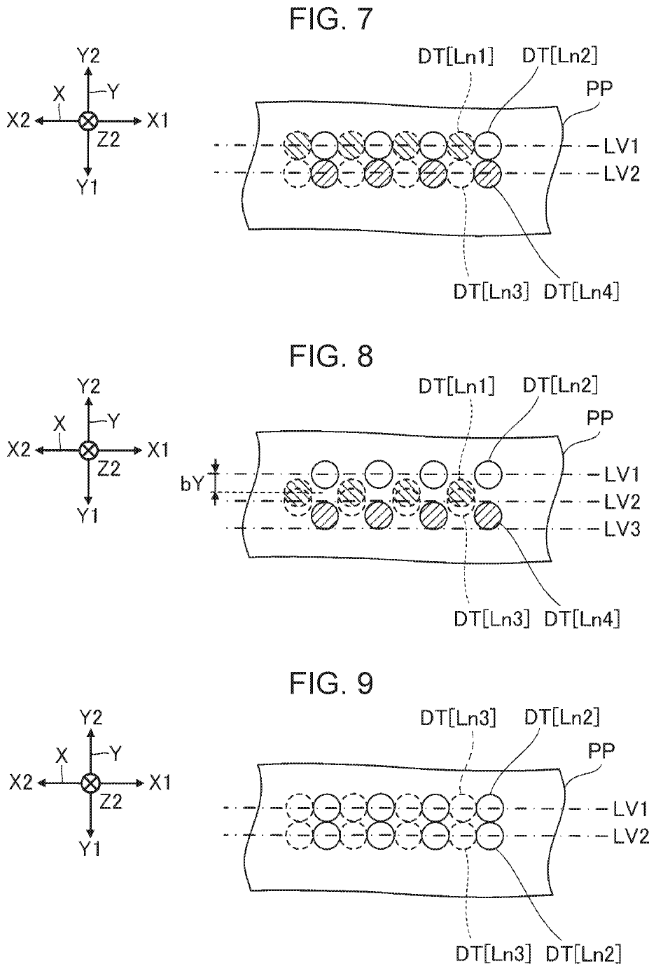

As the work gap WG is wider, the time required for the ink droplet to land on the recording medium PP is longer. Since the recording medium PP is rotated at a constant speed during this time, the amount of deviation between the landing position of the ink droplet on the recording medium PP and the designed landing position is large. In other words, as the work gap WG is wide, the landing position of the ink droplet on the recording medium PP deviates rearward in the rotational direction from the designed landing position. In addition, when the time from the discharge of the ink from the nozzle N to the landing of the ink on the recording medium PP is long, the time for which the landing position is affected by the air flow generated by the rotation of the recording medium PP is long, and the landing position of the ink on the recording medium PP deviates. An example of the deviation between the landing positions will be described with reference to FIGS. 7, 8, and 9.

FIG. 7 is a view showing an example of the landing positions when the work gaps WG[Ln1] to WG[Ln4] of the first to fourth nozzle rows Ln1 to Ln4 are the same. FIG. 8 is a view showing an example of the landing positions when the work gap WG[Ln1] of the first nozzle row Ln1 and the work gap WG[Ln2] of the second nozzle row Ln2 are different from each other and the work gap WG[Ln3] of the third nozzle row Ln3 and the work gap WG[Ln4] of the fourth nozzle row Ln4 are different from each other. In FIGS. 7, 8, and 9, dots DT[Ln1] to DT[Ln4] are shown. When i is an integer in the range from 1 to 4, the dots DT[Lni] are dots formed by the ink droplets discharged from the nozzles N belonging to the i-th nozzle row Lni. In FIGS. 7, 8, and 9, the dot DT[Ln1] is shown as a circle having a dashed outline with hatching applied from the upper left to the lower right. The dot DT[Ln2] is shown as a white circle having a solid outline. The dot DT[Ln3] is shown as a white circle having a dashed outline. The dot DT[Ln4] is shown as a solid circle with hatching applied from the upper right to the lower left.

As understood from FIG. 7, when the work gaps WG[Ln1] to WG[Ln4] of the first to fourth nozzle rows Ln1 to Ln4 are the same, the dot DT[Ln1] and the dot DT[Ln2] are disposed on a virtual straight line LV1 along the X-axis. Similarly, the dot DT[Ln3] and the dot DT[Ln4] are disposed on a virtual straight line LV2 along the X-axis. The dot DT[Ln2] and the dot DT[Ln4] are disposed with almost no gap therebetween in the direction along the Y-axis. Similarly, the dot DT[Ln1] and the dot DT[Ln3] are disposed with almost no gap therebetween in the direction along the Y-axis.

FIG. 8 shows an example in which the dot DT[Ln1] and the dot DT[Ln4] deviate from the intended landing positions by a distance bY in the Y1 direction due to the influence of the configuration in which some of the work gaps WG are different from the other work gaps WG among the work gaps WG[Ln1] to WG[Ln4] of the first to fourth nozzle rows Ln1 to Ln4, which is different from the example shown in FIG. 6. As understood from FIG. 8, the landing position of the ink droplet discharged from the first nozzle row Ln1 deviates from the landing position of the ink droplet discharged from the second nozzle row Ln2 since the work gap WG[Ln1] of the first nozzle row Ln1 is wider than the work gap WG[Ln2] of the second nozzle row Ln2. Similarly, the landing position of the ink droplet discharged from the fourth nozzle row Ln4 deviates from the landing position of the ink droplet discharged from the third nozzle row Ln3 since the work gap WG[Ln4] of the fourth nozzle row Ln4 is wider than the work gap WG[Ln3] of the third nozzle row Ln3. As a result, the quality of the image formed on the recording medium PP deteriorates.

FIG. 9 is a view showing an example of the landing positions of the ink droplets when the printing operation is performed using the second nozzle row Ln2 and the third nozzle row Ln3. FIG. 9 shows an example in which no ink droplets are discharged from each nozzle of the first nozzle row Ln1 and the fourth nozzle row Ln4 whose work gaps WG are wide and only the nozzles N of the second nozzle row Ln2 and the third nozzle row Ln3 whose work gaps WG are narrow and equal are used. As shown in FIG. 9, the deviation between the landing positions of the ink droplets can be reduced by using only the nozzles N of the second nozzle row Ln2 and the third nozzle row Ln3.

However, in the aspect shown in FIG. 9, in one drive cycle which is a cycle for discharging the ink droplets, the number of nozzles N capable of discharging the ink droplets is halved as compared to the aspect shown in FIG. 8. As a result, the period required for the printing operation is longer. In addition, in the aspect shown in FIG. 9, the gap between two dots DT formed by the ink droplets discharged from the nozzles N of the second nozzle row Ln2 in the direction along the Y-axis is narrower than that in the aspect shown in FIG. 8. Specifically, the gap between the two dots DT formed by the nozzles N of the second nozzle row Ln2 in the direction along the Y-axis is the gap between the virtual straight line LV1 and the virtual straight line LV2 in the direction along the Y-axis in the aspect shown in FIG. 9 and is the gap between the virtual straight line LV1 and a virtual straight line LV3 in the direction along the Y-axis in the aspect shown in FIG. 8. The same applies to the third nozzle row Ln3 as to the second nozzle row Ln2. Therefore, the rotation speed of the recording medium PP in the aspect shown in FIG. 9 needs to be lower than the rotation speed of the recording medium PP in the aspect shown in FIG. 8. In addition, when only the nozzles N of the second nozzle row Ln2 and the third nozzle row Ln3 are used, at least one of the rotation speed of the recording medium PP and the discharge timing of the second nozzle row Ln2 and the third nozzle row Ln3 is adjusted such that the dot DT[Ln2] and the dot DT[Ln3] are disposed on the virtual straight line LV1 along the X-axis on the recording medium PP. Here, a method is also considered that adjusts the discharge timing corresponding to the landing position deviation between the nozzle rows Ln with different work gaps WG to reduce the deviation between the landing positions on the recording medium PP. However, as the work gap WG is wider, the degree of influence of the air flow and the like generated by the rotation of the recording medium PP is larger. Therefore, it is difficult to ensure the quality of the printed image only by adjusting the discharge timing according to the difference between the work gaps WG. However, the quality of the printed image can be ensured by executing the printing operation using the second nozzle row Ln2 and the third nozzle row Ln3 whose work gaps WG are narrow and equal while adjusting at least one of the rotation speed of the recording medium PP and the discharge timing of the second nozzle row Ln2 and the third nozzle row Ln3.

As described above, the deviation between the landing positions of the ink droplets can be reduced by executing the printing operation without using the nozzle rows Ln with a wide work gap WG. However, when the nozzle rows Ln having a wide work gap WG are not used, the period required for the printing operation is longer than that when the printing operation is executed using the nozzle rows Ln having a wide work gap WG. In addition, the user of the liquid discharge apparatus 100 may request the liquid discharge apparatus 100 to prioritize the improvement of the quality of the image or may request the liquid discharge apparatus 100 to prioritize the shortening of the period required for the printing operation.

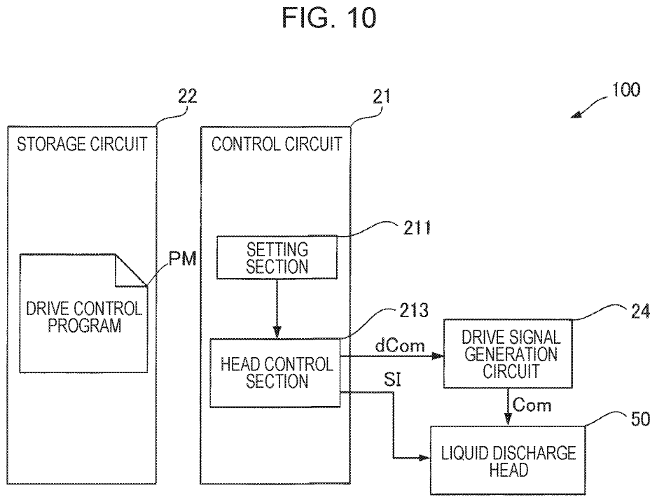

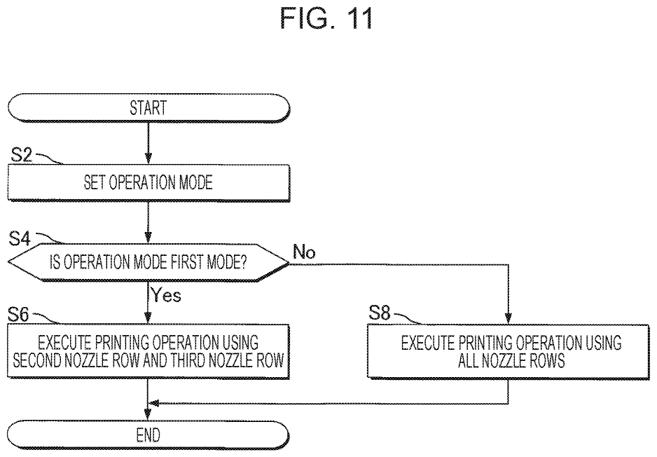

Therefore, in the present embodiment, the liquid discharge apparatus 100 has two operation modes for changing the nozzle rows Ln used for the printing operation among the four nozzle rows Ln. Of the two operation modes, a first mode is an operation mode in which the printing operation is executed using the second nozzle row Ln2 and the third nozzle row Ln3 as shown in FIG. 9 and is a mode in which priority is given to improving the quality of the image formed on the recording medium PP. Of the two operation modes, a second mode is an operation mode in which the printing operation is executed using the four nozzle rows Ln as shown in FIG. 8 and is a mode in which priority is given to shortening the period required for the printing operation. In addition, the second nozzle row Ln2 and the third nozzle row Ln3 are an example of “a part of the nozzle rows”, and the first nozzle row Ln1 and the fourth nozzle row Ln4 are an example of “the other nozzle rows different from the part of the nozzle rows”. The functions and operations of the first embodiment will be described with reference to FIGS. 10 and 11.

### A6: Functions and Operations of Liquid Discharge Apparatus 100

FIG. 10 is a diagram showing the functions of the liquid discharge apparatus 100. FIG. 11 is a flowchart showing an operation of the control circuit 21 during the printing operation. The storage circuit 22 stores a drive control program PM that defines the operation according to the present embodiment. The control circuit 21 reads the drive control program PM stored in the storage circuit 22 and executes the read drive control program PM to function as a setting section 211 and a head control section 213.

In Step S2 shown in FIG. 11, the control circuit 21 functions as the setting section 211 to set the operation mode. Specifically, for example, the control circuit 21 inquires of the external apparatus 200 whether to set the operation mode to the first mode or the second mode. The external apparatus 200 displays, for example, a screen for selecting whether to set the operation mode to the first mode or the second mode on a display device of the external apparatus 200. The user selects the first mode when giving priority to improving the quality of the image and selects the second mode when giving priority to shortening the period required for the printing operation. The external apparatus 200 transmits mode information indicating the operation mode selected by the user to the liquid discharge apparatus 100. The control circuit 21 sets the mode to the operation mode indicated by the mode information received from the external apparatus 200.

After the process in Step S2 is ended, the control circuit 21 determines whether or not the operation mode set by Step S2 is the first mode in Step S4. When the determination result in Step S4 is “Yes”, the control circuit 21 functions as the head control section 213 and executes the printing operation using the second nozzle row Ln2 and the third nozzle row Ln3 in Step S6. For example, when ink droplets are discharged from all of the nozzles N of the second nozzle row Ln2 and the third nozzle row Ln3, the head control section 213 transmits the waveform designation signal dCom defining the drive waveform PX to the drive signal generation circuit 24 and further transmits the print signal SI indicating that ink droplets are to be discharged from all of the nozzles N of the second nozzle row Ln2 and the third nozzle row Ln3 to the liquid discharge head 50. Then, the drive signal Com having the drive waveform PX is supplied to the drive elements 51f corresponding to all of the nozzles N of the second nozzle row Ln2 and the third nozzle row Ln3.

On the other hand, when the determination result in Step S4 is “No”, that is, when the operation mode is the second mode, the control circuit 21 functions as the head control section 213 and executes the printing operation using all of the four nozzle rows Ln in Step S8. For example, when the ink droplets are discharged from all of the nozzles N of the four nozzle rows Ln, the head control section 213 transmits the waveform designation signal dCom defining the drive waveform PX to the drive signal generation circuit 24 and further transmits the print signal SI indicating that the ink droplets are to be discharged from all of the nozzles N of the four nozzle rows Ln to the liquid discharge head 50. Then, the drive signal Com having the drive waveform PX is supplied to the drive elements 51f corresponding to all of the nozzles N of the four nozzle rows Ln. Therefore, the shape of the drive waveform PX of the drive signal Com supplied to the drive elements 51f[Ln2] and 51f[Ln3] corresponding to all of the nozzles N of the second nozzle row Ln2 and the third nozzle row Ln3 and the shape of the drive waveform PX of the drive signal Com supplied to the drive elements 51f[Ln1] and 51f[Ln4] corresponding to all of the nozzles N of the first nozzle row Ln1 and the fourth nozzle row Ln4 are the same. In addition, the drive signal Com supplied to the drive elements 51f[Ln2] and 51f[Ln3] is an example of a “first drive signal”. The drive signal Com supplied to the drive elements 51f[Ln1] and 51f[Ln4] is an example of a “second drive signal”. After the process in Step S6 or the process in Step S8 is ended, the control circuit 21 ends the series of processes shown in FIG. 11.

### A7. Summary of First Embodiment

In the following description of the summary of the first embodiment, the “part of the nozzle rows” are the second nozzle row Ln2 and the third nozzle row Ln3, and “the other nozzle rows” are the first nozzle row Ln1 and the fourth nozzle row Ln4.

As described above, the liquid discharge apparatus 100 according to the first embodiment includes the rotation mechanism 30 that rotates the recording medium PP having a cylindrical shape and the liquid discharge head 50 that includes four nozzle rows Ln, each having 0.5×M nozzles N for discharging ink droplets, and that forms an image on the cylindrical side surface of the recording medium PP. Each of the four nozzle rows Ln has 0.5×M nozzles N arranged along the X-axis. The four nozzle rows Ln are arranged in parallel. The rotation mechanism 30 rotates the recording medium PP about the central axis AX of the recording medium PP as a rotation axis in a state where the central axis AX is parallel to the X-axis. In the first embodiment, a method for driving the liquid discharge apparatus 100 can also be defined. When the operation mode in which the nozzle rows Ln used to form an image among the plurality of nozzle rows Ln are changed is the first mode, in Step S6, the control circuit 21 of the liquid discharge apparatus 100 discharges the ink droplets from the second nozzle row Ln2 and the third nozzle row Ln3 among the four nozzle rows Ln. When the operation mode is the second mode different from the first mode, in Step S8, the liquid discharge apparatus 100 discharges the ink droplets from the second nozzle row Ln2 and the third nozzle row Ln3, and the first nozzle row Ln1 and the fourth nozzle row Ln4 different from the second nozzle row Ln2 and the third nozzle row Ln3 among the four nozzle rows Ln. The work gaps WG[2] and WG[3] are narrower than the work gaps WG[1] and WG[4].

According to the first embodiment, the printing operation can be efficiently performed on the recording medium PP having a cylindrical shape. Specifically, the liquid discharge apparatus 100 can execute the printing operation in the first mode to give priority to improving the quality of the image formed on the recording medium PP and can execute the printing operation in the second mode to give priority to shortening the period required for the printing operation.

The first mode is a mode in which the priority is given to improving the quality of the image, and the second mode is a mode in which the priority is given to shortening the period required for forming an image.

As described above, in the liquid discharge apparatus 100 according to the first embodiment, when the user requests high-quality image, the printing operation can be executed in the first mode to obtain the recording medium PP on which a high-quality image has been formed. On the other hand, when the user requests to shorten the period required for the printing operation, the printing operation can be executed in the second mode to shorten the period required for the printing operation.

In addition, the rotation speed of the recording medium PP in the first mode is lower than the rotation speed of the recording medium PP in the second mode.

In the first embodiment, a high-quality image can be formed in the first mode by setting the rotation speed of the recording medium PP in the first mode to be lower than the rotation speed of the recording medium PP in the second mode. Further, the period required for the printing operation in the second mode can be shortened by setting the rotation speed of the recording medium PP in the second mode to be higher than the rotation speed of the recording medium PP in the first mode.

In addition, the ink droplets are discharged from the nozzles N[Ln2] and N[Ln3] by supplying the drive signal Com to the drive elements 51f[Ln2] and 51f[Ln3], and the ink droplets are discharged from the nozzles N[Ln1] and N[Ln4] by supplying the drive signal Com to the drive elements 51f[Ln1] and 51f[Ln4]. In the second mode, the shape of the drive waveform PX of the drive signal Com supplied to the drive elements 51f[Ln2] and 51f[Ln3] and the shape of the drive waveform PX of the drive signal Com supplied to the drive elements 51f[Ln1] and 51f[Ln4] are the same.

As a method of reducing the amount of deviation between the landing positions of the ink droplets discharged from each of the nozzle rows LN having different work gaps WG on the recording medium PP when the work gap WG is different depending on the nozzle row Ln, an aspect is considered that increases the flight speed of the ink droplets discharged from the nozzle rows Ln having a wide work gap WG. However, in this aspect, the shape of the drive waveform PX of the drive signal Com supplied to the drive elements 51f[Ln2] and 51f[Ln3] and the shape of the drive waveform PX of the drive signal Com supplied to the drive elements 51f[Ln1] and 51f[Ln4] need to be different from each other. When the drive signals Com with the drive waveforms PX having different shapes are supplied to the liquid discharge head 50, the size of the drive signal generation circuit 24 increases. Therefore, according to the first embodiment, even when the printing operation is performed on the recording medium PP having a cylindrical shape, it is possible to execute the printing operation corresponding to the image quality requested by the user of the liquid discharge apparatus 100 in a simple manner, without generating various drive waveforms PX.

### B: Modification Examples

Each of the above-described aspects can be modified in various ways. Specific modification examples that can be applied to each of the above-described aspects will be described below. Any two or more aspects selected from the following examples may be combined as appropriate as long as the aspects are not mutually inconsistent.

### B1: First Modification Example

In the first embodiment, the operation mode of the liquid discharge apparatus 100 is set by the operation of the user. However, a method of setting the operation mode is not limited thereto. A first modification example will be described below.

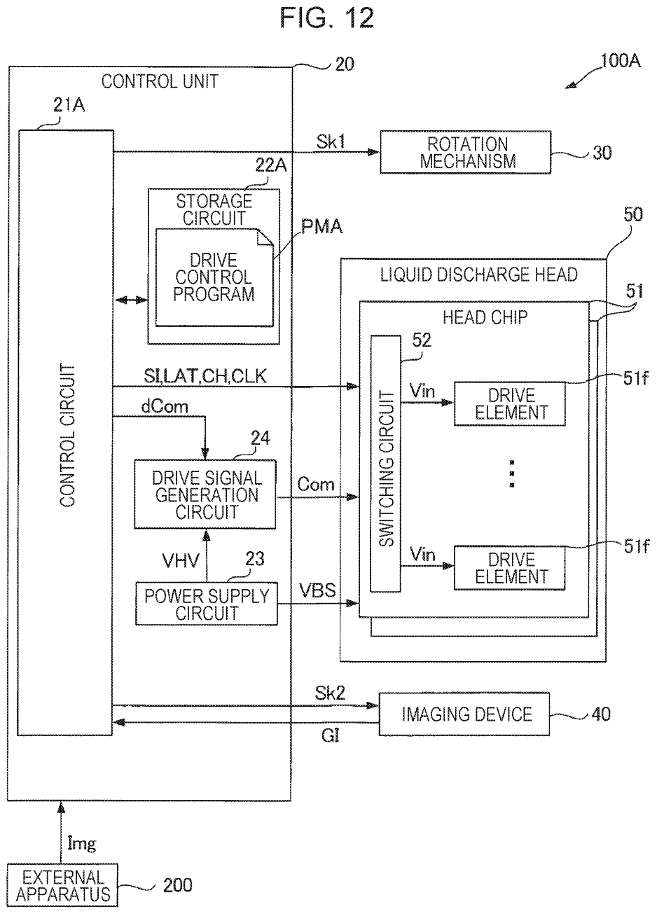

FIG. 12 is a diagram showing an electrical configuration of a liquid discharge apparatus 100A according to the first modification example. The liquid discharge apparatus 100A is different from the liquid discharge apparatus 100 in that the liquid discharge apparatus 100A has a storage circuit 22A instead of the storage circuit 22, has a control circuit 21A instead of the control circuit 21, and further has an imaging device 40.

The storage circuit 22A is different from the storage circuit 22 in that the storage circuit 22A stores a drive control program PMA instead of the drive control program PM. The control circuit 21A is different from the control circuit 21 in that the control circuit 21A controls the imaging device 40.

The imaging device 40 captures the image formed on the recording medium PP. Specifically, the imaging device 40 includes, for example, an imaging optical system and an imaging element. The imaging optical system is an optical system including at least one imaging lens, may include various optical elements such as prisms, and may include a zoom lens, a focus lens, and the like. The imaging element is, for example, a CCD image sensor, a CMOS image sensor, or the like. CCD is an abbreviation for Charge Coupled Device. CMOS is an abbreviation for Complementary MOS.

The control circuit 21A transmits an imaging instruction Sk2 to the imaging device 40. When receiving the imaging instruction Sk2, the imaging device 40 transmits image information GI indicating the image formed on the recording medium PP to the control circuit 21A.

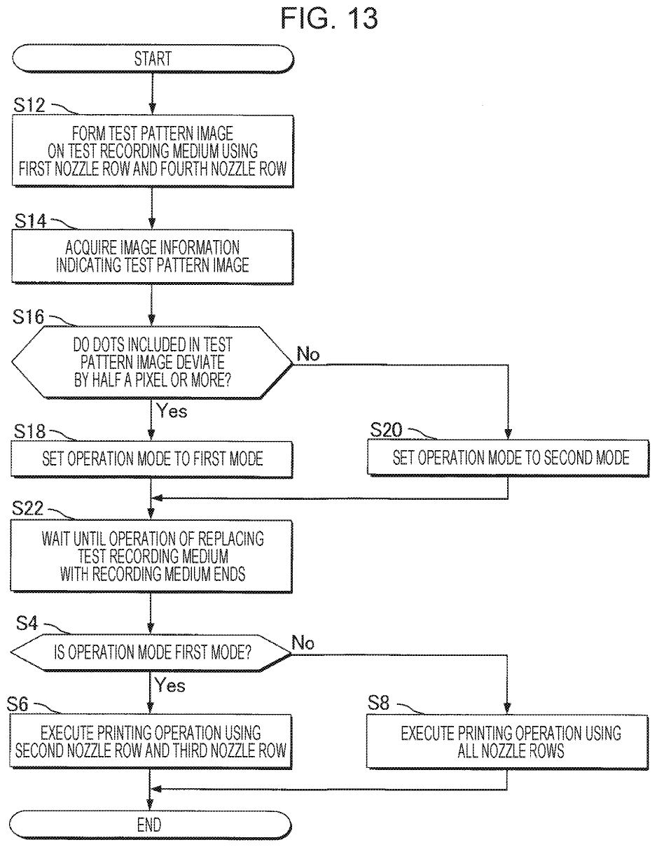

FIG. 13 is a flowchart showing an operation of the control circuit 21A. The flowchart shown in FIG. 13 is different from the flowchart shown in FIG. 11 in that a series of processes from Step S12 to Step S22 are executed instead of Step S2. Hereinafter, only the differences from the flowchart shown in FIG. 11 will be described.

Before executing the flowchart shown in FIG. 13, the user of the liquid discharge apparatus 100A installs the rotation mechanism 30 so as to support a test recording medium. The test recording medium has the same cylindrical shape as the recording medium PP. The test recording medium is preferably made of the same material as the recording medium PP, but may be made of a different material.

In Step S12, the control circuit 21A forms a test pattern image on the test recording medium using the first nozzle row Ln1 and the fourth nozzle row Ln4. The test pattern image may be any image as long as the deviation between the dots can be identified, and the content of the image is optional.

After the process in Step S12 is ended, in Step S14, the control circuit 21A transmits the imaging instruction Sk2 for the test pattern image to the imaging device 40 and acquires the image information GI indicating the test pattern image from the imaging device 40.

After the process in Step S14 is ended, in Step S16, the control circuit 21A determines whether or not the dot of the test pattern image deviates from the intended landing position by half a pixel or more, based on the image information GI. The intended landing position is a position where the ink droplet lands when the work gap WG[Ln1] of the first nozzle row Ln1 and the work gap WG[Ln4] of the fourth nozzle row Ln4 are the same as the work gap WG[Ln2] of the second nozzle row Ln2 and the work gap WG[Ln3] of the third nozzle row Ln3.

When the determination result in Step S16 is “Yes”, that is, when the amount of deviation between the landing positions of the ink droplets is large due to the difference between the work gap WG[Ln1] and the work gap WG[Ln4], and the work gap WG[Ln2] and the work gap WG[Ln3], the control circuit 21A sets the operation mode to the first mode in Step S18. On the other hand, when the determination result in Step S16 is “No”, that is, when the amount of deviation between the landing positions of the ink droplets is small even though the work gap WG[Ln1] and the work gap WG[Ln4] are different from the work gap WG[Ln2] and the work gap WG[Ln3], the control circuit 21A sets the operation mode to the second mode in Step S20.

After the process in Step S18 or Step S20 is ended, in Step S22, the control circuit 21A waits until the operation of replacing the test recording medium with the recording medium PP is ended. Specifically, after the process in Step S18 or Step S20 is ended, the control circuit 21A transmits a request to perform the operation of replacing the test recording medium with the recording medium PP to the external apparatus 200. The external apparatus 200 displays a screen indicating the request to perform the operation of replacing the test recording medium with the recording medium PP on the display device of the external apparatus 200. In addition, the screen includes a button indicating the end of the operation. After replacing the test recording medium with the recording medium PP, the user of the liquid discharge apparatus 100 operates an input device of the external apparatus 200 to press the button indicating the end of the operation. When the button indicating the end of the operation is pressed, the external apparatus 200 transmits information indicating the end of the operation to the liquid discharge apparatus 100. After the process in Step S22 is ended, the control circuit 21A executes the process in Step S4.

Further, the printing of the test pattern image on the test recording medium may be performed by discharging ink droplets from all of the first nozzle row Ln1 to the fourth nozzle row Ln4. In this case, it is determined whether or not the positions of the dot DT[Ln1] and the dot DT[Ln2] in the Y-axis direction deviate by half a pixel or more and whether or not the positions of the dot DT[Ln3] and the dot DT[Ln4] in the Y-axis direction deviate by half a pixel or more.

As described above, in a driving method according to the first modification example, before an image is formed on the recording medium PP, in Step S12, the control circuit 21A performs control to discharge ink droplets from the first nozzle row Ln1 and the fourth nozzle row Ln4 to the test recording medium having the same cylindrical shape as the recording medium PP, thereby forming the test pattern image. Then, in Steps S16 to S20, the control circuit 21A sets the operation mode to the first mode when the dot included in the test pattern image deviates from the intended landing position by half a pixel or more and sets the operation mode to the second mode when the dot included in the test pattern image deviates from the intended landing position by less than half a pixel. Then, the control circuit 21A forms an image on the recording medium PP in the set operation mode in Step S22 and Steps S4 to S8.

When the deviation between the dot formed by the ink droplet discharged from the nozzle N of the first nozzle row Ln1 and the dot formed by the ink droplet discharged from the nozzle N of the second nozzle row Ln2 and the deviation between the dot formed by the ink droplet discharged from the nozzle N of the third nozzle row and the dot formed by the ink droplet discharged from the nozzle N of the fourth nozzle row Ln4 are less than half a pixel, it can be said that the influence of the difference between the work gaps WG on the deviation between the landing positions is small. Therefore, when the influence of the difference between the work gaps WG on the deviation between the landing positions is small, the printing operation is executed in the second mode, which makes it possible to shorten the period required for the printing operation while suppressing the deterioration of the quality of the image formed on the recording medium PP.

### B2: Second Modification Example

In the first embodiment, the operation mode is set according to the deviation between the dots formed by the ink droplets discharged from the nozzles N of the first nozzle row Ln1 and the fourth nozzle row Ln4. However, the method of setting the operation mode is not limited thereto. Hereinafter, a second modification example will be described.

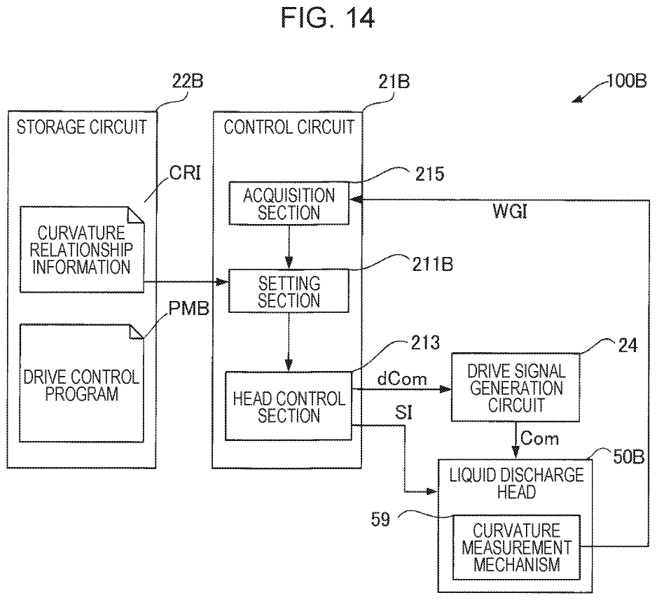

FIG. 14 is a diagram showing the functions of a liquid discharge apparatus 100B according to the second modification example. The liquid discharge apparatus 100B is different from the liquid discharge apparatus 100 in that the liquid discharge apparatus 100B has a storage circuit 22B instead of the storage circuit 22, has a control circuit 21B instead of the control circuit 21, and has a liquid discharge head 50B instead of the liquid discharge head 50. The liquid discharge head 50B is different from the liquid discharge head 50 in that the liquid discharge head 50B further has a curvature measurement mechanism 59.

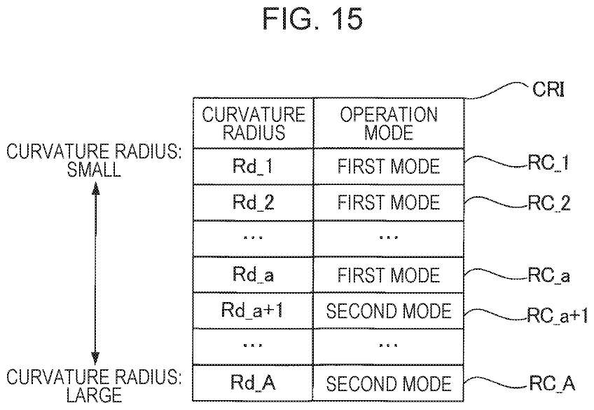

The storage circuit 22B is different from the storage circuit 22 in that the storage circuit 22B stores a drive control program PMB instead of the drive control program PM and further stores curvature relationship information CRI. The curvature relationship information CRI will be described with reference to FIG. 15.

FIG. 15 is a view showing an example of the content of the curvature relationship information CRI. The curvature relationship information CRI has A records RC in which a numerical value indicating a curvature radius and operation mode information indicating the operation mode are associated with each other for each curvature radius. A is an integer that is equal to or greater than 2. The numerical value indicating the curvature radius is an example of “information related to curvature”. The information related to curvature is not limited to the numerical value indicating the curvature radius and may be a numerical value indicating the curvature. The curvature is the reciprocal of the curvature radius.

The curvature relationship information CRI shown in FIG. 15 includes a record RC_1 having the smallest curvature radius Rd_1 to a record RC having the largest curvature radius RD_A. As the curvature radius Rd_1 is smaller, the difference between the work gaps WG[Ln2] and [Ln3] and the work gaps WG[Ln1] and WG[Ln4] is larger. Therefore, when the curvature radius Rd_1 is small and the printing operation is performed in the second mode, the quality of the image deteriorates significantly. Therefore, it is preferable to execute the printing operation in the first mode. On the other hand, when the curvature radius Rd_1 is large, the difference between the quality of the image obtained in the first mode and the quality of the image obtained in the second mode is small. Therefore, it is preferable to execute the printing operation in the second mode. In the example shown in FIG. 15, the records RC_1 to RC_a having numerical values indicating the curvature radii Rd_1 to Rd_a have information indicating the first mode. Records RC_a+1 to RC_A having numerical values indicating the curvature radii Rd_a+1 to Rd_A have information indicating the second mode.

The operation mode information is information indicating the first mode or information indicating the second mode. The curvature relationship information CRI is generated by, for example, a manufacturer of the liquid discharge head 50 or a manufacturer of the liquid discharge apparatus 100.

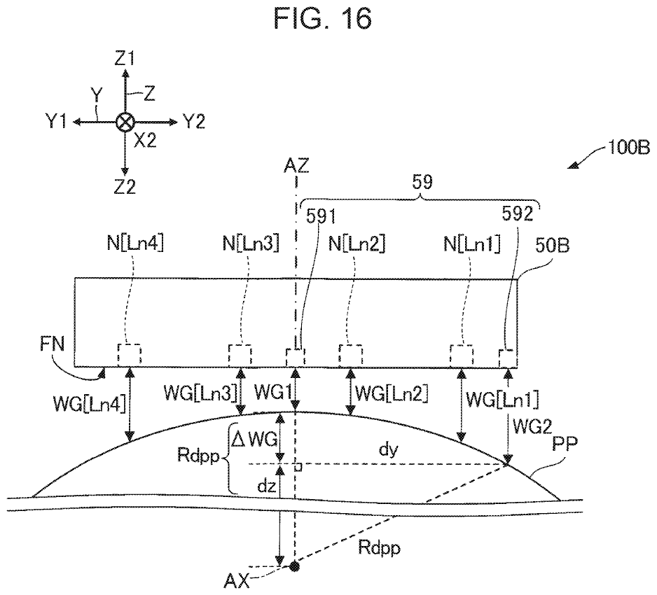

The description returns to FIG. 14. The curvature measurement mechanism 59 measures the curvature radius of the recording medium PP. A method of measuring the curvature radius will be described with reference to FIG. 16.

FIG. 16 is a view showing an example of the method of measuring the curvature radius. The curvature measurement mechanism 59 has a distance sensor 591 and a distance sensor 592. The distance sensor 591 is provided at a position that overlaps with the symmetry axis AZ when viewed in the X2 direction on the nozzle surface FN of the liquid discharge head 50B. The distance sensor 592 is provided at a position that is in the vicinity of the side wall in the X2 direction when viewed in the X2 direction on the nozzle surface FN.

The distance sensor 591 measures the work gap WG1. The distance sensor 592 measures the work gap WG2.

The curvature radius Rdpp of the recording medium PP satisfies the relationship represented by the following Equation (1) according to the Pythagorean theorem:

$${Rdpp}^{2} = {dy}^{2} + {dz}^{2} . \qquad ( 1 )$$

Here, dy is a gap between the distance sensor 591 and the distance sensor 592 along the Y-axis and is a known numerical value at the time of manufacturing the liquid discharge head 50. dz satisfies the relationship represented by the following Equation (2):

$$dz = Rdpp - Δ WG \qquad ( 2 )$$

ΔWG is a difference between the work gap WG1 and the work gap WG2. Therefore, the curvature radius Rdpp can be calculated by substituting Equation (2) into dz in Equation (1). However, the method of measuring the curvature radius Rdpp is not limited to the method shown in FIG. 16, and other known methods may be used.

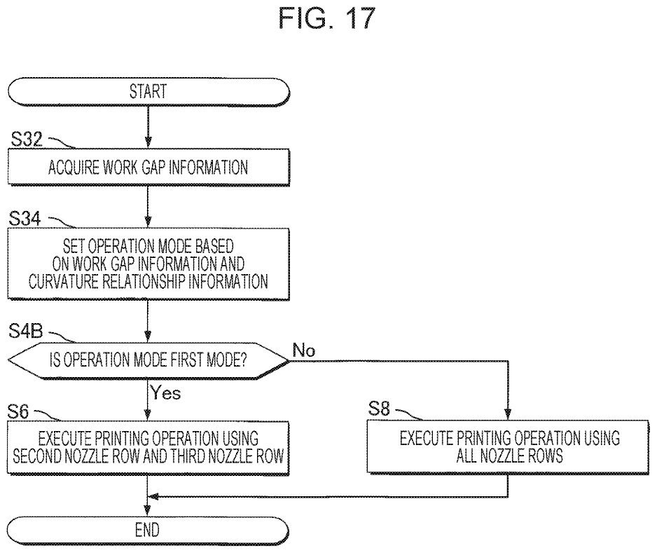

The description returns to FIG. 14. The control circuit 21B reads the drive control program PMB stored in the storage circuit 22B and executes the read drive control program PMB to function as a setting section 211B, a head control section 213, and an acquisition section 215. Each of the functions will be described with reference to FIG. 17.

FIG. 17 is a flowchart showing an operation of the control circuit 21B. The flowchart shown in FIG. 17 is different from the flowchart shown in FIG. 11 in that a series of processes in Step S32 and Step S34 is executed instead of Step S2 and Step S4B is executed instead of Step S4. Hereinafter, only the differences from the flowchart shown in FIG. 11 will be described.

In Step S32, the control circuit 21B functions as the acquisition section 215 to acquire work gap information WGI from the curvature measurement mechanism 59. The work gap information WGI has information indicating the work gap WG1 and information indicating the work gap WG2. The work gap information WGI is an example of “curvature information related to curvature of the recording medium”.

After the process in Step S32 is ended, in Step S34, the control circuit 21B functions as the setting section 211B to set the operation mode of the liquid discharge apparatus 100B based on the work gap information WGI and the curvature relationship information CRI. Specifically, the control circuit 21B searches for the record RC having a value indicating the same curvature radius as the curvature radius Rdpp of the recording medium PP calculated from the work gap information WGI, from A records RC of the curvature relationship information CRI. The control circuit 21B sets the operation mode of the liquid discharge apparatus 100B to the operation mode indicated by the operation mode information included in the searched record RC.

After the process in Step S34 is ended, the control circuit 21B determines whether or not the operation mode set based on the processing result in Step S34 is the first mode in Step S4B.

As described above, in the driving method according to the second modification example, the control circuit 21B acquires the work gap information WGI, which is an example of the curvature information related to the curvature of the recording medium PP, in Step S32, sets the operation mode based on the curvature relationship information CRI indicating the relationship between the information related to the curvature and the operation mode and the work gap information WGI, and executes the printing operation in the set operation mode.

According to the second modification example, the printing operation can be executed in the operation mode suitable for the curvature of the recording medium PP. Specifically, when the curvature radius of the recording medium PP is small and the printing operation is performed in the second mode, the quality of the image deteriorates significantly. Therefore, the liquid discharge apparatus 100B can execute the printing operation in the first mode to maintain the quality of the image formed on the recording medium PP. On the other hand, when the curvature radius of the recording medium PP is large, the difference between the quality of the image obtained in the first mode and the quality of the image obtained in the second mode is small. Therefore, the printing operation is executed in the second mode, which makes it possible to shorten the period required for the printing operation while suppressing the deterioration of the quality of the image formed on the recording medium PP.

### B3: Third Modification Example

In each of the above-described aspects, the liquid discharge head 50 is disposed over the entire range of the recording medium PP in the direction along the X-axis. However, as described above, a plurality of liquid discharge heads 50 may be disposed over the entire range of the recording medium PP in the direction along the X-axis. Hereinafter, a third modification example will be described.

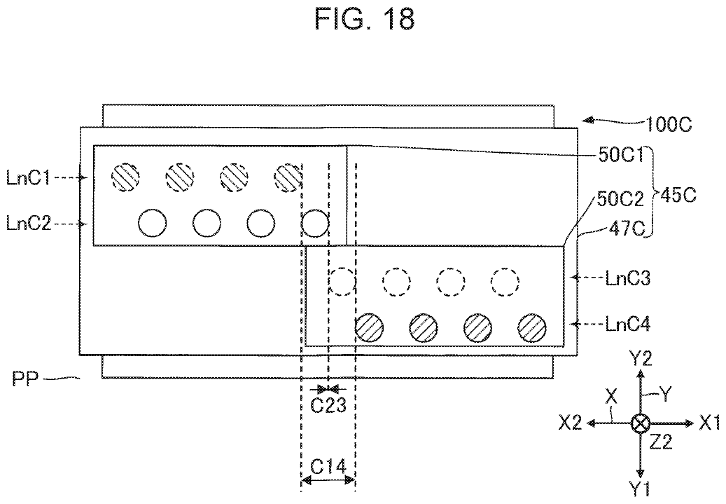

FIG. 18 is a schematic view showing an example of a configuration of a liquid discharge apparatus 100C according to the third modification example. The liquid discharge apparatus 100C is different from the liquid discharge apparatus 100 in that the liquid discharge apparatus 100C has a head module 45C instead of the head module 45. Further, in FIG. 18, only the head module 45C and the recording medium PP are shown, and the other elements are not shown.

The head module 45C is a line head having two liquid discharge heads 50C that are disposed such that a plurality of nozzles N are distributed over the entire range of the recording medium PP in the direction along the X-axis. The head module 45C includes a liquid discharge head 50C1, a liquid discharge head 50C2, and a head fixing substrate 47C. Hereinafter, the liquid discharge head 50C1 and the liquid discharge head 50C2 may be collectively referred to as liquid discharge heads 50C without distinction. The head fixing substrate 47C is a substrate that fixes the two liquid discharge heads 50C. Further, in the third modification example, one head fixing substrate 47 fixes the two liquid discharge heads 50C. However, the present disclosure is not limited thereto. For example, the head module 45C may have two head fixing substrates 47 that fix the two liquid discharge heads 50C, respectively.

The liquid discharge head 50C1 has a first nozzle row LnC1 and a second nozzle row LnC2. The liquid discharge head 50C2 has a third nozzle row LnC3 and a fourth nozzle row LnC4. The liquid discharge head 50C2 has the same shape as the liquid discharge head 50C1. Hereinafter, the first nozzle row LnC1, the second nozzle row LnC2, the third nozzle row LnC3, and the fourth nozzle row LnC4 may be referred to as nozzle rows LnC without distinction. The four nozzle rows LnC are disposed to be parallel to the X-axis. When viewed in the direction along the Y-axis, a nozzle N located at the end of the second nozzle row LnC2 in the X2 direction is located between a nozzle N located at the end of the first nozzle row LnC1 in the X2 direction and a nozzle N of the first nozzle row LnC1 located in the X2 direction with respect to the nozzle N. Similarly, when viewed in the direction along the Y-axis, a nozzle N located at the end of the fourth nozzle row LnC4 in the X2 direction is located between a nozzle N located at the end of the third nozzle row LnC3 in the X2 direction and a nozzle N of the third nozzle row LnC3 located in the X1 direction with respect to the nozzle N. The pitches between the nozzles N in the first to fourth nozzle rows LnC1 to LnC4 are the same. The nozzle N of the first nozzle row LnC1 and the nozzle N of the second nozzle row LnC2 deviate from each other by half a pitch in the X-axis direction. The nozzle N of the third nozzle row LnC3 and the nozzle N of the fourth nozzle row LnC4 deviate from each other by half a pitch in the X-axis direction. The nozzle N located at the end of the first nozzle row LnC1 in the X1 direction and the nozzle N located at the end of the third nozzle row LnC3 in the X2 direction deviate from each other by one pitch in the X-axis direction. The nozzle N located at the end of the second nozzle row LnC2 in the X1 direction and the nozzle N located at the end of the fourth nozzle row LnC4 in the X2 direction deviate from each other by one pitch in the X-axis direction. In the following description, when i is an integer in the range from 1 to 4, [LnCi] may be assigned to an element related to the nozzle row LnCi. Further, patterns are assigned to the nozzles N of the four nozzle rows LnC in order to make it easy to understand the correspondence with the dots, which will be described below.

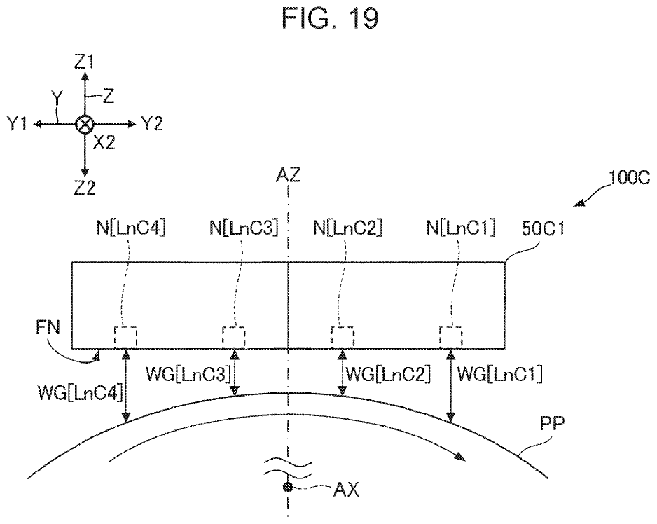

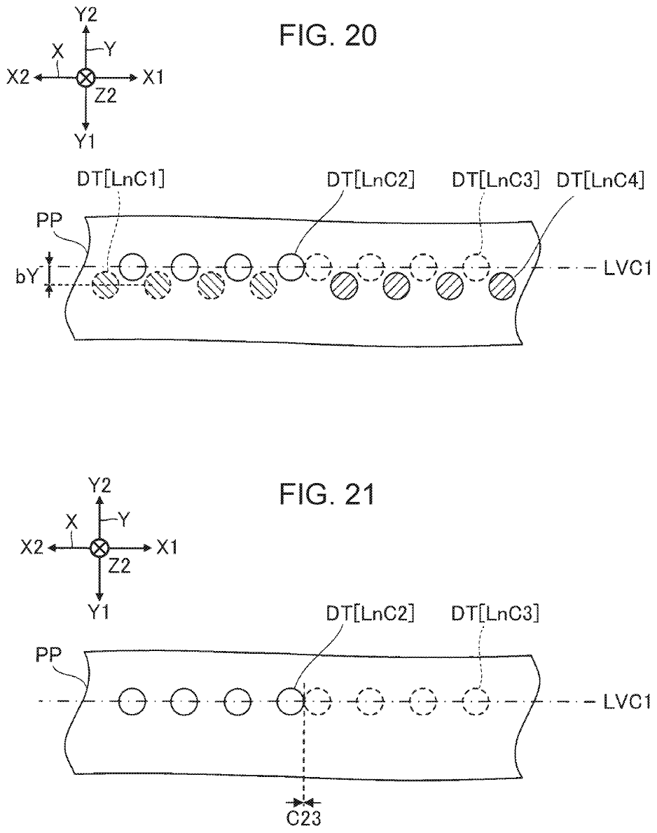

FIG. 19 is a view showing the work gaps WG in the third modification example. FIG. 19 is an enlarged view showing the vicinity of the liquid discharge heads 50C1 and 50C2 when the liquid discharge apparatus 100C is viewed in the X2 direction. When viewed in the X2 direction, the four nozzle rows LnC are disposed line-symmetrically with respect to the symmetry axis AZ that passes through the central axis AX and is parallel to the Z-axis. As understood from FIG. 19, when i is an integer in the range from 1 to 4, the positions of the four nozzle rows LnCi are the same as the positions of the nozzle rows LnC in the first embodiment. Therefore, the work gaps WG[LnCi] in the third modification example are also the same as the work gaps WG[LnC] in the first embodiment. The landing positions of the ink droplets in the third modification example will be described with reference to FIGS. 20 and 21.

FIG. 20 is a view showing an example of the landing positions of the ink droplets when the printing operation is executed in the second mode in the third modification example. FIG. 21 is a view showing an example of the landing positions of the ink droplets when the printing operation is executed in the first mode in the third modification example. In FIGS. 20 and 21, when i is an integer in the range from 1 to 4, the same patterns as the dots DT[Lni] are assigned to the dots DT[LnCi]. In addition, for ease of understanding, in FIGS. 20 and 21, the ink droplets discharged from the nozzles N of the second nozzle row LnC2 and the ink droplets discharged from the nozzles N of the third nozzle row LnC3 will be described in a state where there is no influence of the air flow generated by the rotation of the recording medium PP since the work gap WG is narrow.

A virtual straight line LVC1 shown in FIGS. 20 and 21 indicates the position in the direction along the Y-axis in which the dots DT formed by the ink droplets discharged from the four nozzle rows LnC are disposed when the work gap WG of each of the four nozzle rows LnC is equal to the work gap WG[LnC2]. In other words, when the work gap WG of each of the four nozzle rows LnC is equal to the work gap WG[LnC2], the dots DT[LnC1] formed by the ink droplets discharged from the first nozzle row LnC1 and the dots DT[LnC2] formed by the ink droplets discharged from the second nozzle row LnC2 are alternately arranged on the virtual straight line LVC1, and the dots DT[LnC3] formed by the ink droplets discharged from the third nozzle row LnC3 and the dots DT[LnC4] formed by the ink droplets discharged from the fourth nozzle row LnC4 are alternately arranged on the virtual straight line LVC1. FIG. 20 shows an example in which, since the work gap WG[LnC1] of the first nozzle row LnC1 and the work gap WG[LnC4] of the fourth nozzle row LnC4 are wider than the work gap WG[LnC2], the dot DT[LnC1] and the dot DT[LnC4] deviate from the landing positions of the dot DT[LnC2] and the dot DT[LnC3] by a distance bY in the Y1 direction. As understood from FIG. 20, in the second mode, the quality of the image formed on the recording medium PP deteriorates. On the other hand, in the first mode, the deviation of the landing position of the ink droplet from the virtual straight line LVC1 can be reduced by using only the nozzles N of the second nozzle row LnC2 and the third nozzle row LnC3.

### B4: Fourth Modification Example

In the third modification example, the head module 45C has two identical liquid discharge heads 50C, but may have different liquid discharge heads 50. Hereinafter, a fourth modification example will be described.

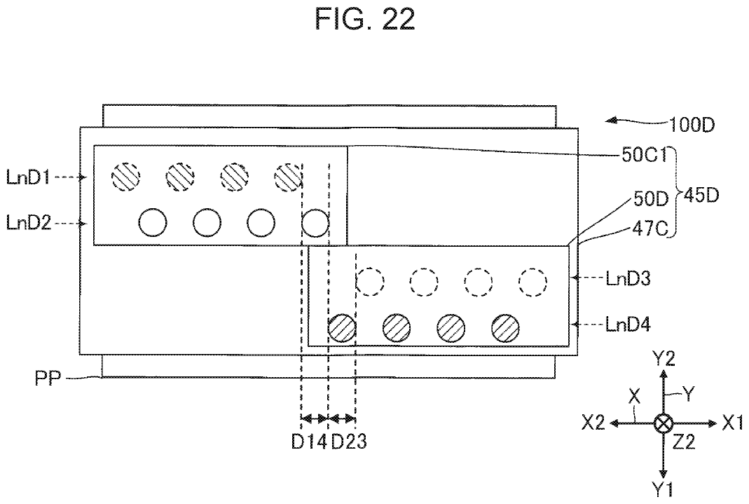

FIG. 22 is a schematic view showing an example of a configuration of a liquid discharge apparatus 100D according to the fourth modification example. The liquid discharge apparatus 100D is different from the liquid discharge apparatus 100C in that the liquid discharge apparatus 100D has a head module 45D instead of the head module 45C. In FIG. 22, only the head module 45D and the recording medium PP are shown, and the other elements are not shown.

The head module 45D is different from the head module 45C in that the head module 45D has a liquid discharge head 50D instead of the liquid discharge head 50C2. The liquid discharge head 50D is in a mirror image relationship with the liquid discharge head 50C1 in a plan view.

For ease of understanding, in the fourth modification example, four nozzle rows Ln included in the head module 45D may be referred to as four nozzle rows LnD. Further, two nozzle rows Ln included in the liquid discharge head 50C1 of the head module 45D may be referred to as a first nozzle row LnD1 and a second nozzle row LnD2. Furthermore, two nozzle rows Ln included in the liquid discharge head 50D may be referred to as a third nozzle row LnD3 and a fourth nozzle row LnD4. The four nozzle rows LnD are disposed to be parallel to the X-axis. The disposition relationship between the first nozzle row LnD1 and the second nozzle row LnD2 among the four nozzle rows LnD is the same as the disposition relationship between of the first nozzle row LnC1 and the second nozzle row LnC2. When viewed in the direction along the Y-axis, a nozzle N located at the end of the third nozzle row LnD3 in the X2 direction is located between a nozzle N located at the end of the fourth nozzle row LnD4 in the X2 direction and a nozzle N of the fourth nozzle row LnD4 located in the X1 direction with respect to the nozzle N. The pitches between the nozzles N of the first to fourth nozzle rows LnD1 to LnD4 are the same. The nozzle N of the first nozzle row LnD1 and the nozzle N of the second nozzle row LnD2 deviate from each other by half a pitch in the X-axis direction. The nozzle N of the third nozzle row LnD3 and the nozzle N of the fourth nozzle row LnD4 deviate from each other by half a pitch in the X-axis direction. The nozzle N located at the end of the first nozzle row LnD1 in the X1 direction and the nozzle N located at the end of the fourth nozzle row LnD4 in the X2 direction deviate from each other by one pitch in the X-axis direction. The nozzle N located at the end of the second nozzle row LnD2 in the X1 direction and the nozzle N located at the end of the third nozzle row LnC3 in the X2 direction deviate from each other by one pitch in the X-axis direction. When i is an integer in the range from 1 to 4, [LnDi] may be assigned to an element related to the nozzle row LnDi. Further, patterns are assigned to the nozzles N of the four nozzle rows LnD in order to make it easy to understand the correspondence with the dots, which will be described below.

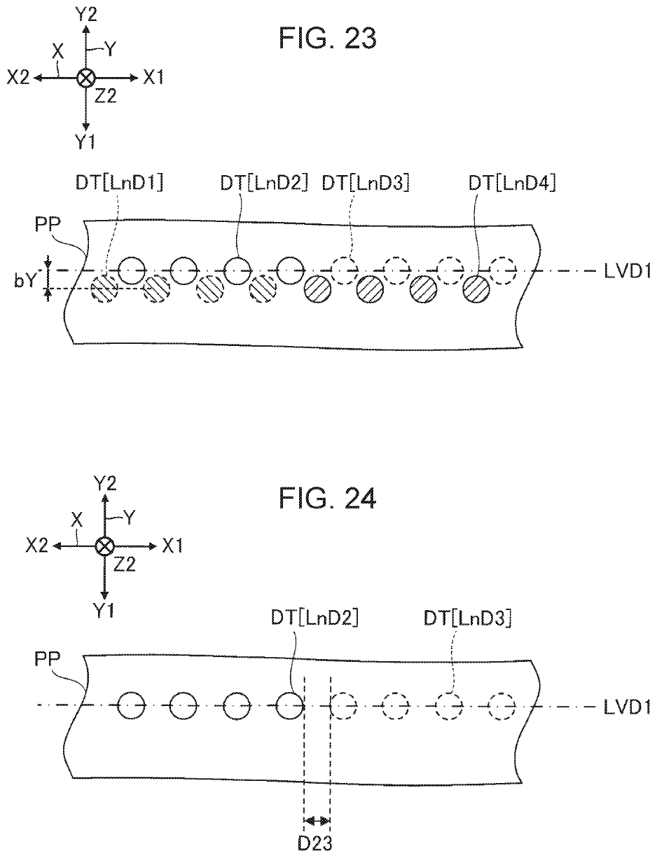

When i is an integer in the range from 1 to 4, the work gap WG[LnDi] in the fourth modification example is the same as the work gap WG[LnCi] and thus will not be shown and described. The landing positions of the ink droplets in the fourth modification example will be described with reference to FIGS. 23 and 24.

FIG. 23 is a view showing an example of the landing positions of the ink droplets when the printing operation is executed in the second mode in the fourth modification example. FIG. 24 is a view showing an example of the landing positions of the ink droplets when the printing operation is executed in the first mode in the fourth modification example. In FIGS. 23 and 24, when i is an integer in the range from 1 to 4, the same patterns as the dots DT[Lni] are assigned to the dots DT[LnDi]. In addition, for ease of understanding, in FIGS. 23 and 24, the ink droplets discharged from the nozzles N of the second nozzle row LnD2 and the ink droplets discharged from the nozzles N of the third nozzle row LnD3 will be described in a state where there is no influence of the air flow generated by the rotation of the recording medium PP since the work gap WG is narrow.

A virtual straight line LVD1 shown in FIGS. 23 and 24 indicates the position in the direction along the Y-axis in which the dots DT formed by the ink droplets discharged from the four nozzle rows LnD are disposed when the work gap WG of each of the four nozzle rows LnD is equal to the work gap WG[LnD2]. In other words, when the work gap WG of each of the four nozzle rows LnD is equal to the work gap WG[LnD2], the dots DT[LnD1] formed by the ink droplets discharged from the first nozzle row LnD1 and the dots DT[LnD2] formed by the ink droplets discharged from the second nozzle row LnD2 are alternately arranged on the virtual straight line LVD1, and the dots DT[LnD3] formed by the ink droplets discharged from the third nozzle row LnD3 and the dots DT[LnD4] formed by the ink droplets discharged from the fourth nozzle row LnD4 are alternately arranged on the virtual straight line LVD1. FIG. 23 shows an example in which, since the work gap WG[LnD1] of the first nozzle row LnD1 and the work gap WG[LnD4] of the fourth nozzle row LnD4 are wider than the work gap WG[LnD2], the dot DT[LnD1] and the dot DT[LnD4] deviate from the intended landing positions by a distance bY in the Y1 direction. As understood from FIG. 23, in the second mode, the quality of the image formed on the recording medium PP deteriorates. On the other hand, in the first mode, the deviation of the landing position of the ink droplet from the virtual straight line LVD1 can be reduced by using only the nozzles N of the second nozzle row LnD2 and the third nozzle row LnD3.

The third modification example and the fourth modification example will be compared. In the third modification example, the nozzle N at the end of the second nozzle row LnC2 in the X1 direction and the nozzle N at the end of the third nozzle row LnC3 in the X2 direction deviate from each other by half a pitch in the X-axis direction. Therefore, a gap C23 between the dots DT at the joint, that is, between the dot DT[LnC2] formed by the ink droplet discharged from the second nozzle row LnC2 and the dot DT[LnC3] formed by the ink droplet discharged from the third nozzle row LnC3 is narrower than the gap between the dots DT in each nozzle row LnC. On the other hand, in the fourth modification example, the nozzle N located at the end of the second nozzle row LnD2 in the X1 direction and the nozzle N located at the end of the third nozzle row LnD3 in the X2 direction deviate from each other by one pitch in the X-axis direction. Therefore, a gap D23 between the dots DT at the joint, that is, between the dot DT[LnD2] formed by the ink droplet discharged from the second nozzle row LnD2 and the dot DT[LnD3] formed by the ink droplets discharged from the third nozzle row LnD3 is the same as the gap between the dots DT in each nozzle row LnD. As a result, the quality of the image obtained when the printing operation is executed in the first mode in the fourth modification example is higher than the quality of the image obtained when the printing operation is executed in the first mode in the third modification example. On the other hand, in the third modification example, it is possible to construct the liquid discharge apparatus 100C using two identical liquid discharge heads 50C, without increasing the number of types of parts.

### B5: Fifth Modification Example

In each of the above-described aspects, the second nozzle row Ln2 and the third nozzle row Ln3 correspond to the “part of the nozzle rows”, and the first nozzle row Ln1 and the fourth nozzle row Ln4 correspond to “the other nozzle rows”. However, the present disclosure is not limited thereto. For example, when the liquid discharge apparatus 100 has two nozzle rows Ln and the two nozzle rows Ln are not disposed line-symmetrically with respect to the symmetry axis Az, of the two nozzle rows Ln, a nozzle row Ln having a narrow work gap WG corresponds to the “part of the nozzle rows”, and a nozzle row Ln having a wide work gap WG corresponds to “the other nozzle rows”.

### B6: Sixth Modification Example

In each of the above-described aspects, the nozzle rows Ln having a narrow work gap WG correspond to the “part of the nozzle rows”, and the nozzle rows Ln having a wide work gap WG correspond to “the other nozzle rows”. However, the present disclosure is not limited thereto. For example, when a discharge failure occurs as a result of wear of the nozzle plate 51c including the nozzle row Ln having a narrow work gap WG, the liquid discharge apparatus 100 may execute the printing operation in the first mode using only the nozzle row Ln having a wide work gap WG and may execute the printing operation in the second mode using the nozzle row Ln having a wide work gap WG and the nozzle row Ln having a narrow work gap WG.

### B7: Seventh Modification Example

In each of the above-described aspects, the liquid discharge head 50 includes the drive element 51f, but may include a heating element instead of the piezoelectric element. The heating element heats the ink in the pressure chamber C to generate air bubbles in the pressure chamber C.

### B8: Other Modification Examples

The liquid discharge apparatus 100 can be adopted in various apparatuses, such as a facsimile machine and a copier, in addition to the apparatus dedicated to printing. However, the application of the liquid discharge apparatus according to the present disclosure is not limited to printing. For example, a liquid discharge apparatus that discharges a solution of a coloring material is used as a manufacturing apparatus that forms a color filter of a liquid crystal display device. Further, a liquid discharge apparatus that discharges a solution of a conductive material is used as a manufacturing apparatus that forms wiring lines and electrodes of a wiring substrate.

What is claimed is:

1. A method for driving a liquid discharge apparatus including a rotation mechanism that is configured to rotate a recording medium having a cylindrical shape and a liquid discharge head that is configured to form an image on a side surface of the recording medium, the liquid discharge head including a plurality of nozzle rows having a plurality of nozzles for discharging a liquid, each of the plurality of nozzle rows having a plurality of nozzles arranged along a first axis, the plurality of nozzle rows being arranged in parallel, the rotation mechanism rotating the recording medium about a central axis of the cylindrical shape of the recording medium as a rotation axis in a state where the central axis is parallel to the first axis, the method comprising:
discharging the liquid from a part of the plurality of nozzle rows when an operation mode in which a nozzle row used to form the image among the plurality of nozzle rows is changed is a first mode; and
discharging the liquid from the part of the plurality of nozzle rows and the other nozzle rows different from the part of the plurality of nozzle rows when the operation mode is a second mode different from the first mode, wherein
a gap from an opening end of the nozzle in the part of the plurality of nozzle rows to the recording medium is narrower than a gap from an opening end of the nozzle in the other nozzle rows to the recording medium.

2. The driving method according to claim 1, wherein
the first mode is a mode in which priority is given to improving quality of the image, and
the second mode is a mode in which priority is given to shortening a period required for forming the image.

3. The driving method according to claim 1, wherein
before the image is formed on the recording medium, the liquid is discharged from the other nozzle rows to a test recording medium having the same cylindrical shape as the recording medium to form a test pattern image,
when a dot included in the test pattern image deviates from an intended landing position by half a pixel or more, the operation mode is set to the first mode,
when the dot included in the test pattern image deviates from the intended landing position by less than half a pixel, the operation mode is set to the second mode, and
the image is formed on the recording medium in the set operation mode.

4. The driving method according to claim 1, wherein
curvature information related to curvature of the recording medium is acquired,
the operation mode is set based on a curvature relationship information indicating a relationship between the curvature information and the operation mode, and
the image is formed on the recording medium in the set operation mode.

5. The driving method according to claim 1, wherein
a rotation speed of the recording medium in the first mode is lower than a rotation speed of the recording medium in the second mode.

6. The driving method according to claim 1, wherein
a first drive signal is supplied to drive elements corresponding to a plurality of nozzles included in the part of the plurality of nozzle rows to discharge the liquid from the plurality of nozzles included in the part of the plurality of nozzle rows,
a second drive signal is supplied to drive elements corresponding to a plurality of nozzles included in the other nozzle rows to discharge the liquid from the plurality of nozzles included in the other nozzle rows, and
in the second mode, a shape of a drive waveform of the first drive signal is the same as a shape of a drive waveform of the second drive signal.

7. A liquid discharge apparatus comprising:
a rotation mechanism that is configured to rotate a recording medium having a cylindrical shape;
a liquid discharge head that is configured to form an image on a side surface of the recording medium, the liquid discharge head including a plurality of nozzle rows having a plurality of nozzles for discharging a liquid; and
a control section that is configured to control the rotation mechanism and the liquid discharge head, wherein
each of the plurality of nozzle rows has a plurality of nozzles arranged along a first axis,
the plurality of nozzle rows are arranged in parallel,
the rotation mechanism rotates the recording medium about a central axis of the cylindrical shape of the recording medium as a rotation axis in a state where the central axis is parallel to the first axis,
the control section performs control to discharge the liquid from a part of the plurality of nozzle rows when an operation mode in which a nozzle row used to form the image among the plurality of nozzle rows is changed is a first mode,
the control section performs control to discharge the liquid from the part of the plurality of nozzle rows and the other nozzle rows different from the part of the plurality of nozzle rows when the operation mode is a second mode different from the first mode, and
a gap from an opening end of the nozzle in the part of the plurality of nozzle rows to the recording medium is narrower than a gap from an opening end of the nozzle in the other nozzle rows to the recording medium.
